(19) United States
(12) Patent Application Publication
(10) Pub. No.: US 2023/0079667 A1
(43) Pub. Date: Mar. 16, 2023

(54) INTELLIGENT, DYNAMIC RISK MANAGEMENT AND MITIGATION, WITH CORRECTIVE ACTION MONITORING AND AUTONOMOUS OPERATOR RISK/SAFETY LEVEL DETERMINATION FOR INSURANCE OF VEHICLES, OPERATORS, AND DRIVERS

(71) Applicant: OVERHAUL GROUP, INC., AUSTIN, TX (US)

(72) Inventors: BARRY CONLON, LEANDER, TX (US); DAVID BROE, BLACKROCK (IE); RONALD GREENE, AUSTIN, TX (US); JOHN PROSSER, ENNISKERRY (IE); DYLAN CONNOLLY, RATJMEW (IE)

(21) Appl. No.: 17/820,873

(22) Filed: Aug. 18, 2022

Related U.S. Application Data
(60) Provisional application No. 63/234,502, filed on Aug. 18, 2021.

(51) Int. Cl. G06Q 40/08

(52) U.S. Cl. CPC G06Q 40/08

(57) ABSTRACT

A method for autonomous risk management using safety ratings for drivers/operators of commercial vehicles. The method includes receiving vehicle, operator, and/or driver (VOD) data associated with events involving and a respective safety rating of the vehicle, operator and/or driver. The method includes aggregating the received VOD data into a VOD safety record and determining, by evaluating the VOD data along with any previously-received, historical VOD data, a corresponding safety rating associated with one or more of the driver/operator. The method includes associating the corresponding safety rating with the VOD safety record and updating a stored copy of the VOD safety record with the VOD data and the corresponding safety rating. The VOD safety record is made accessible via a network portal to at least one insurance company computer for use during evaluation of insurability and premium cost for insuring one or more of the vehicle, the operator, and/or the driver.

### PRIORITY & RELATED APPLICATIONS

The present application claims priority from U.S. Provisional Application No. 63/234,502, filed on Aug. 18, 2021, with the entire content of that provisional application being incorporated herein by reference.

### BACKGROUND

### 1. Technical Field

The present disclosure is generally related to commercial vehicles used for transporting cargo, and in particular to a method, a system, computer devices, and computer program product for providing autonomous risk management to promote safer operation of commercial vehicles and improve the insurability of operators and drivers of commercial vehicles.

### 2. Description of the Related Art

The cost of insurance premiums for owning and operating commercial vehicles, and in particular cargo transporting vessels, such as tractor-trailers, continues to rise at an alarming rate for the owners, operators, and drivers of these vehicles. Both larger operators with fleets of commercial vehicles as well as owner-operators with just one vehicle or a small number of vehicles have experienced significant increases in their insurance premiums. These premium increases are in part a result of the growing number of nuclear verdicts against commercial operators when commercial vehicles are involved in an accident. These nuclear verdicts result in huge monetary awards, which are usually paid out by the insurance company to the party bringing suit.

As a result, the insurance companies attempt to mitigate their potential exposure to these large monetary awards by significantly increasing the premiums to insure the drivers and operators of commercial vehicles and the vehicles themselves. All operators, including those who maintain a good safety record among his/her/its drivers, are automatically placed in the high-risk category as a commercial operator and is thus charged the higher commercial premiums associated with that group of insured. These high insurance costs are of major concern to the cargo transportation industry, as more and more operators are driven out of business due to the very high insurance premiums. There is an overall lack of objectivity in the determination of insurance premiums for cargo carriers, as even the safest operators with little or no history of loss are forced to pay the higher premiums that are arbitrarily applied to the entire industry.

### SUMMARY

The illustrative embodiments of the present disclosure provide a method, a risk management and operator safety rating (RMOSR) data processing system (DPS) and methods provided via a shipment and event tracking server, an operator computer, and associated computer program products that provide dynamic risk management of operators, drivers, and commercial vehicles and that assess and recognizes safety of drivers and operators of commercial vehicles. One aspect of the disclosure presents a system of interconnected, distributed DPSs, communicatively coupled to localized environmental and vehicle sensors, and which collect and aggregate data from multiple different sources into a single unified interface presenting commercial vehicles, operators, and drivers. The system facilitates autonomous implementation of safety processes, including directing corrective actions in order to reduce both (i) incidences of risks to the vehicle, cargo, and driver, and (ii) financial losses to the operator, insurance companies, or other invested third party. The system further enables autonomous tracking and updating of events associated with safety ratings for each of the vehicle, operator, and driver. The system provides insurance companies with direct access to up-to-date and accurate safety ratings for use in determining levels of insurability and associated premiums when insuring an operator, a driver, and/or a commercial vehicle.

One aspect of the disclosure provides a method for autonomous risk management using safety ratings for drivers/operators of commercial vehicles. The method includes receiving vehicle, operator, and/or driver (VOD) data associated with events involving and a respective safety rating of the vehicle, operator and/or driver. The method includes aggregating the received VOD data into a VOD safety record and determining, by evaluating the VOD data along with any previously-received, historical VOD data, a corresponding safety rating associated with one or more of the driver/operator. The method includes associating the corresponding safety rating with the VOD safety record and updating a stored copy of the VOD safety record with the VOD data and the corresponding safety rating. The VOD safety record is made accessible via a network portal to at least one insurance company computer for use during evaluation of insurability and premium cost for insuring one or more of the vehicle, the operator, and/or the driver.

According to another aspect of the disclosure, the method includes determining and assigning a specific set of corrective actions, from among a plurality of corrective actions within a database, the specific set of corrective actions being predetermined to at least one of (i) mitigate the safety-related event and (ii) reduce a re-occurrence of an associated type of safety-related event. The method further includes transmitting a corrective action notification with the assigned set of corrective actions and a recommended response time to a second device associated with at least one of the operator, the driver, and the vehicle, with instructions for the operator and/or driver to perform the corrective action within a prescribed timeframe. The method further includes initiating a timer concurrently with transmitting the notification with the assigned set of corrective actions, and tracking, using the timer and completion signal received from another device, a response time of the driver or operator to complete the assigned set of corrective actions. The method includes determining and applying a safety rating adjustment factor from among a graduated scale of safety rating adjustment factors, based on the response time of the driver or operator, the safety rating adjustment factor being one of a lower positive or a higher negative adjustment factor for faster response times and even more negative adjustment factor for longer response times and response times that are longer than the recommended response time.

According to yet another aspect of the disclosure, an access portal is provided to allow direct access by an insurance company computer to safety ratings and other data related to insurability of different operators registered with the RMOSR DPS. The method includes matching the VOD data with pre-identified types of event data that are each correlated to specific safety metrics having associated thresholds utilized for evaluating vehicle, driver and operator safety ratings. The method also includes correlating the driver and operator safety rating to an insurability rating that is assigned to the corresponding driver and/or operator, the insurability rating being utilized as an objective measure to determine a cost of insurance provided to the driver and/or operator by an insurance provider. The method further includes providing the insurability rating as accessible data within an insurance company portal accessible via the network by computer devices of insurance companies.

In one or more embodiments, the method further includes detecting a login by an insurance device to the RMOSR DPS via the insurance company portal and receiving an entry of an operator identifier associated with an operator being tracked by within the VOD safety rating DB. The method includes accessing the VOD safety records of the operator within the VOD safety rating DB. The method then includes generating and displaying a graphical user interface (GUI) presenting a set of formatted information comprising a VOD safety rating of the operator and a plurality of additional events and data utilized within a determination of the VOD safety rating that collectively provides a snapshot of the insurability of the operator.

Another aspect of the disclosure provides an operator access portal to allow direct access by an operator device or computer to historical events data and other safety related data of the vehicles and drivers managed by the operator. The operator is one that is registered with the RMOSR DPS. The method includes detecting a login by an operator device to the RMOSR DPS via an operator accessible portal and identifying an operator ID associated with the login. The method includes retrieving, from the VOD safety DB, a plurality of operator related VOD event data and VOD safety ratings corresponding to one or more drivers and one or more vehicles managed by an operator associated with the operator ID. The method includes presenting, within a series of graphical user interfaces, formatted data representing a historical view of events associated with at least one of the one or more drivers and the one or more vehicles. The method includes presenting, within at least one graphical user interface (GUI), an overview of an insurability rating of at least one of the operator, the one or more drivers, and the one or more vehicles.

In one or more additional aspects, the method includes generating and presenting a set of corrective action GUIs comprising a corrective action assigning GUI and a corrective action tracking GUI. In response to a selection of the corrective action assigning GUI, the method includes presenting a list of drivers and associated events that can require a corrective action. The method includes enabling operator selection of a specific corrective action from a plurality of pre-established corrective actions to assign to a selected driver and enabling operator selection of a due date for completing the corrective action. The method further includes automatically forwarding the corrective action with the due date to a device of the driver to whom the corrective action is assigned.

According to yet another related aspect, in response to selection of the corrective action tracking GUI, the method further includes generating and presenting a GUI with a select list of drivers to whom a corrective action has been previously assigned for completion and populating within the GUI a completion status of each corrective action assigned, including an indication of which corrective actions have not been completed by the assigned due date. The method includes activating a driver notification and correction protocol, which informs each driver who has not completed an assigned corrective action by the assigned due date of a penalty or other recourse action to be imposed on that driver.

According to one aspect of the disclosure, the RMOSR DPS includes a communication subsystem and a memory having stored thereon a RMOSR module with program code for determining and assigning a safety and insurability rating to one or more of a driver, an operator, and a commercial vehicle, based on collected real-time data and historical data. The DPS also includes at least one processor communicatively coupled to the communication subsystem and to the memory. The at least one processor processes the program code for the RMOSR module, which configures the DPS to receive, from at least one network-connected, second electronic device via the communication subsystem, a plurality of vehicle, operator, and/or driver (VOD) data associated with events involving, and a respective safety rating of, the vehicle, operator and/or driver. The DPS is configured to aggregate the received VOD data into a VOD safety record associated with at least one of the driver and the operator and determine, by evaluating the VOD data along with any previously-received, historical VOD data, a corresponding safety rating associated with one or more of the driver and the operator. The DPS is configured to associate the corresponding safety rating with the VOD safety record and update a stored copy of the VOD safety record with the VOD data and the corresponding safety rating, the VOD safety record being accessible via a network portal to at least one insurance company computer for use during evaluation of insurability and premium cost for insuring one or more of the vehicle, the operator, or the driver.

The processor further configures the DPS to: parse the received VOD data for information corresponding to a safety-related event involving the driver or vehicle; access available contextual data related to the vehicle, driver, operator, geographic location, road and traffic conditions, weather, or environment provided by at least one secondary device or sensor that provides a corresponding sensor data and is communicatively linked to the DPS; categorize a type and severity of the safety-related event, in part based on any received contextual data; and update the VOD safety record based on the type and severity of the safety-related event.

The above presents a general summary of several aspects of the disclosure in order to provide a basic understanding of at least some aspects of the disclosure. The above summary contains simplifications, generalizations and omissions of detail and is not intended as a comprehensive description of the claimed subject matter but, rather, is intended to provide a brief overview of some of the functionality associated therewith. The summary is not intended to delineate the scope of the claims, and the summary merely presents some concepts of the disclosure in a general form as a prelude to the more detailed description that follows. Other systems, methods, functionality, features and advantages of the claimed subject matter will be or will become apparent to one with skill in the art upon examination of the following figures and detailed written description.

### BRIEF DESCRIPTION OF THE FIGURES

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 illustrates an example shipment tracking and communication system, with an integrated risk management and operator safety rating (RMOSR) data processing system (DPS) that performs several of the functions of the disclosure, according to one or more embodiments.

FIG. 2 illustrates an example event tracking and response environment 200 having a distributed network of interconnect sensor and field devices that provide vehicle, operator, and driver (VOD) data utilized by the to track driving behavior, report occurrences of events involving the vehicle and/or driver, and generate and maintain VOD safety ratings utilized in determining insurance premiums, according to one or more embodiments.

FIG. 3 is a block diagram illustrating an example RMOSR DPS or server that operates to provide the various safety features for autonomous risk management, with VOD tracking and driver/operator safety rating generation and updating, in accordance with one or more embodiments.

FIG. 4 illustrates an example workflow for implementing the various features of the disclosure, using a combination of real-time information gathering and non real-time presentation of relevant data and information by the RMOSR DPS, according to one or more embodiments.

FIG. 5 is a block diagram representation of an example database that includes a plurality of different modules and data utilized by the RMOSR DPS to perform the various features described herein, in accordance with one or more embodiments.

FIG. 6 is a block diagram representation of example data presented within an operator window and an insurance company window into VOD safety rating repository that presents relevant details about each driver and/or operator and corrective action completion status, in accordance with one or more embodiments.

FIG. 7 illustrates an example operator dashboard (i.e., user interface window) presented within a display of an operator device logged into an interface of the RMOSR DPS and depicting driving behavior of a plurality of drivers being monitored by the operator, according to one or more embodiments.

FIGS. 8A and 8B illustrate two graphical user interfaces illustrating the operator dashboard presenting data to track speeding events involving the fleet of vehicles owned or managed by the operator, in accordance with embodiments of the disclosure.

FIG. 9 provides a graphical user interface illustrating an example task manager window 900 with a series of tasks 905 and corresponding drivers 910 with associated due dates 915 for completion, according to one or more embodiments

FIG. 10 provides a graphical user interface illustrating an example operator safety rating dashboard in which an overview of a VOD safety record for a particular operator is provided, according to one or more embodiments.

FIGS. 11 and 12 are flow charts of various method performed by RMOSR computer device, to generate and update VOD records, retrieve, transmit and track response to corrective action notifications, and determining driver/operator safety rating for insurability evaluation, according to various different embodiments.

FIGS. 13A, 13B, and 13C present three example graphical user interfaces (GUIs) of driver/operator mobile communication device (MCD) generated by an app following receipt of a corrective action notification and driver interfacing within the corrective action application, in accordance with various embodiments.

### DESCRIPTION OF THE ILLUSTRATIVE EMBODIMENTS

The illustrative embodiments of the present disclosure provide a method, a risk management and operator safety rating (RMOSR) data processing system (DPS) and methods provided via a shipment and event tracking server, an operator computer, and associated computer program products that provide dynamic risk management of operators, drivers, and commercial vehicles and that assess and recognize safety of drivers and operators of commercial vehicles. One aspect of the disclosure presents a system of interconnected, distributed DPSs, communicatively coupled to localized devices and environmental and vehicle sensors, and which collect and aggregate data from multiple different sources into a single unified interface presenting commercial vehicles, operators, and drivers. The system facilitates autonomous implementation of safety processes, including directing corrective actions in order to reduce both (i) incidences of risks to the vehicle, cargo, and driver, and (ii) financial losses to the operator, insurance companies, or other invested third party. The system further enables autonomous tracking and updating of events associated with safety ratings for each of the vehicle, operator, and driver. The system provides insurance companies with direct access to up-to-date and accurate safety ratings for use in determining levels of insurability and associated premiums when insuring an operator, a driver, and/or a commercial vehicle.

One aspect of the disclosure provides a method for autonomous risk management using safety ratings for drivers/operators of commercial vehicles. The method includes receiving vehicle, operator, and/or driver (VOD) data associated with events involving and a respective safety rating of the vehicle, operator and/or driver. The method includes aggregating the received VOD data into a VOD safety record and determining, by evaluating the VOD data along with any previously-received, historical VOD data, a corresponding safety rating associated with one or more of the driver/operator. The method includes associating the corresponding safety rating with the VOD safety record and updating a stored copy of the VOD safety record with the VOD data and the corresponding safety rating. The VOD safety record is made accessible via a network portal to at least one insurance company computer for use during evaluation of insurability and premium cost for insuring one or more of the vehicle, the operator, and/or the driver.

According to another aspect of the disclosure, the method includes determining and assigning a specific set of corrective actions, from among a plurality of corrective actions within a database, the specific set of corrective actions being predetermined to at least one of (i) mitigate the safety-related event and (ii) reduce a re-occurrence of an associated type of safety-related event. The method further includes transmitting a corrective action notification with the assigned set of corrective actions and a recommended response time to a second device associated with at least one of the operator, the driver, and the vehicle (or invested/interested third party), with instructions for the operator and/or driver to perform the corrective action within a prescribed timeframe. The method further includes initiating a timer concurrently with transmitting the notification with the assigned set of corrective actions, and tracking, using the timer and completion signal received from another device, a response time of the driver or operator to complete the assigned set of corrective actions. The method includes determining and applying a safety rating adjustment factor from among a graduated scale of safety rating adjustment factors, based on the response time of the driver or operator, the safety rating adjustment factor being one of a lower positive or a higher negative adjustment factor for faster response times and even more negative adjustment factor for longer response times and response times that are longer than the recommended response time.

Prior to the features presented within the present disclosure, insurance companies that insure commercial vehicles, operators, and drivers typically have little information about the daily operation of and/or safety measures implemented for/by the insured vehicles, or the drivers, or the owner/operator of the vehicle(s), from both before and after the insurance policy is put in place. When an accident or other event occurs that involves the insured vehicle, operator, or driver, the insurance company is left scrambling to collect relevant mitigating or historical operating data to reduce the liability of the driver/operator and thus reduce the size of the insurance payout. At some time following the event, insurance adjusters are assigned to collect the police record, the statements of the driver and the other involved parties, and other data that may be helpful. However, the majority of this information is collected at some time after the event, and in some instances, several days of weeks after the event, and contextual information is lost due to the delay. For example, information relevant to the driver's state or the road or weather conditions at the time of the event is collected at some point later. Information related to the safety record of the driver, etc., may have to be deduced or assumed from local or federal public safety records that may or may not be updated, and such raw data often provides little relevant historical or contextual data related to the driver's true driving habits as he/she operates one or more commercial vehicles.

Thus, without the features of the present disclosure, the insurance companies are left to rely on governmental data and out-of-context raw driving data to make a subjective determination on the safety of the driver. Any driving infraction found on the driver's record triggers a significant increases in insurance premiums during policy renewal and, in some instances, in non-renewal of the driver's insurance altogether. With the number of commercial drivers steadily decreasing, there is no opportunity to simply replace a driver with an infraction on his record with another driver that has a better record. The growing cost of insuring commercial vehicles and finding good drivers adversely affects even the more reliable and safe operators, some of whom are driven out of the shipping business despite having good overall records and safe drivers. Additionally, the higher insurance premiums drive up the cost of shipping, which cost is eventually past on as higher prices to the end customers.

The present disclosure provides insurance companies with reliable, up-to-date information about the safe-worthiness and insurability of individual drivers and operators of commercial vehicles using a plurality of data points obtained from numerous sources that monitor, track, and report on the individual driver's activities that are directly related to and/or relevant to determine a driver/operator's safety rating for insurance purposes. The driver/operator's data is tracked across different commercial vehicles, geographic locations, etc., to ensure a complete historical profile is evaluated when assigning the driver/operator's safety rating. Immediate, direct access to this data is provided to insurance companies that are evaluating the insurability of the driver, operator, and/or commercial vehicle.

As provided within the disclosure, it is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that term is utilized.

Within the description of the features of the disclosure and the accompanying drawings, the embodiments are presented from the perspective of a shipment environment, in which cargo is transported within a tractor-trailer operated by a driver. The tractor-trailer equipment (or vehicle) is owned or managed by an operator, who may have single tractor-trailers or a fleet of tractor-trailers. It is appreciated that while presented as a tractor-trailer vehicle, the disclosure extends to different types of on-terrain transport equipment available, including, but not limited to, flatbeds, dry vans, refrigerated trucks, trains, etc. It is understood that the features and functionality described herein can also be applicable to different types of on-land motorized equipment, such as cars, RVs, busses, motorcycles, and the like, without limitation. Further, the vehicle can, in some instances, be non-motorized vehicles, such as bicycles and other non-motorized form of transportation used to transport commercial shipments.

Additionally, the disclosure utilizes the term “vessel”, in place of vehicle, in order to also account for non-terrain cargo transportation, such as via airplanes and watercrafts and drones. These “vessels” can also be controlled by an operator, such as a pilot, and be involved in one or more events. The underlying features of the disclosure are thus fully applicable to other transportation and/shipping spaces, such as water-based shipping (e.g., ocean cargo or river cargo), where the operators are ship captains and the vessel is either a floating vessel or an amphibious vessel. Air based transportation is also a supported space that can include a framework designed for interfacing by air-based cargo shippers, with the operators being the pilots of the planes, etc. It is further foreseeable that the functionality of the presented framework/environment can be extended to a transportation space involving drone shipments, for example, where the drone operators (pilots) are not co-located with the drone equipment.

For simplicity and completeness, the disclosure is described from the perspective of a shipment that includes a cargo being transported over ground by a transport vessel that is a tractor-trailer, where the operator owns or manages the vehicle. It is appreciated that the operator can also be the driver as in situations with an owner-operated single vehicle. However, the term operator also refers to an entity, which can be a live person or a company, that owns or manages one or more vehicles that can have one or more drivers. The operator is assumed to have at least one of multiple drivers and potentially multiple vehicles. The term driver/operator is utilized to refer to a driver, an operator, or a person who fulfills both roles relative to the commercial vehicle or vessel.

Notably, certain aspects of the disclosure have general applicability to situations that are not shipment related. A driver of any vehicle can benefit from having the event response application on his personal device, even without the need to have real-time upload of event data to a remote server.

The majority of the terms utilized herein are generally known to those in the shipping industry. Certain coined terms are utilized herein in describing the features and functionality of the disclosure. For example, the term “shipment-related entity” is utilized to reference each of the following, without limitation: a cargo, a cargo container, a tractor (e.g., a motorized vehicle/vessel), a trailer (e.g., a wheeled container), a tractor-trailer combination, a transport vessel, a driver/operator, and an operator mobile communication device (MCD). One or more of the shipment-related entities is provided with a location tracking mechanism, such as a GPS transponder, which enables the geographic location of the collective shipment (i.e., all entities for a single shipment) to be determined.

Within the disclosure, the term relevant party refers to and/or can include one or more, or all of, the owner of the cargo, the shipper, the owner of the transport vessel—if different from the operator, the intended recipient of the cargo, an insurance company that insures one or more of the shipment-related entities, an attorney representing one or more of these other parties, and others with a vested interest in the cargo and/or the transport vessel, and/or the operator.

Also, as presented within the description of the disclosure, the term “event” or “shipment-related event” is broadly utilized to represent events that involve or are associated with the vehicle/vessel and/or the driver. An event can be an accident that involves just the vehicle/vessel, another vehicle/vessel, a human, etc. An event can be the vehicle travelling above a speed limit or a recommended limit for the road or weather conditions, based on ELD or other sensor tracking. An event can involve law enforcement, or not involve law enforcement. An event can be a received report of bad driving that is collaborated in some way. An event can be late delivery of a shipment without any recorded cause for the tardiness. An event can be spoilage of goods due to non-compliance with provided shipping requirements (e.g., refrigeration). Other types of events can be tracked and reported to the RMOSR DPS for evaluation and application to the determination of the insurability of the driver/operator and/or adjustments made to the corresponding VOD safety rating. In some instances, an event can be or include an emergency or an emergency event. According to one aspect, each event type can have a different list of relevant parties. For example, the insurance agent may only be relevant for events (e.g., cargo or vehicle theft and collisions) where there is financial liability that has to be covered by the insurance company.

In the following detailed description of exemplary embodiments of the disclosure, specific exemplary embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments but not other embodiments.

The attached figures present various aspects and/or features of the described embodiments; however, certain features may not be expressly presented within the figures and/or the description thereof. Within the descriptions of the different views of the figures, similar elements are provided similar names and reference numerals as those of the previous figure(s). The descriptions of the illustrative embodiments are therefore be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein.

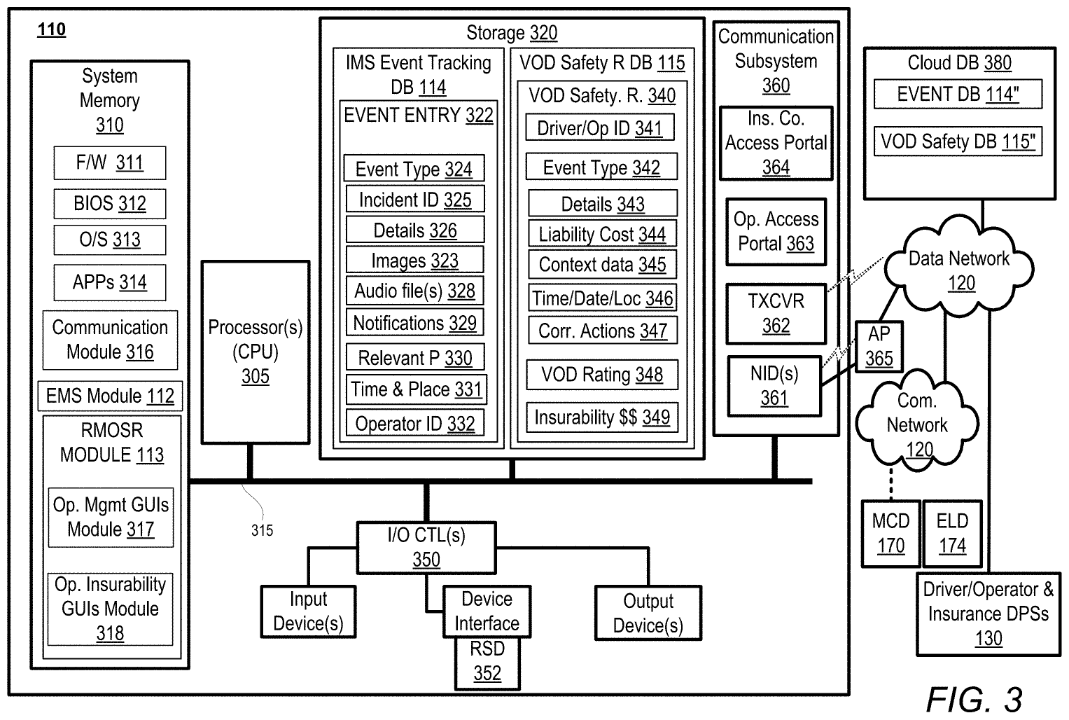

Those of ordinary skill in the art will appreciate that the hardware, firmware/software utility, and software components and basic configuration thereof depicted in the following figures may vary. For example, the illustrative components of RMOSR DPS 110 (e.g., FIG. 3) are not intended to be exhaustive, but rather are representative to highlight some of the components that are utilized to implement certain of the described embodiments. For example, different configurations of RMOSR DPS 110 may be provided, containing other devices/mechanism/components/features, which may be used in addition to or in place of the hardware depicted and/or described, and the devices may be differently configured. The depicted examples are therefore not meant to imply architectural, usage, or other limitations with respect to the presently described embodiments and/or the concepts of the general disclosure.

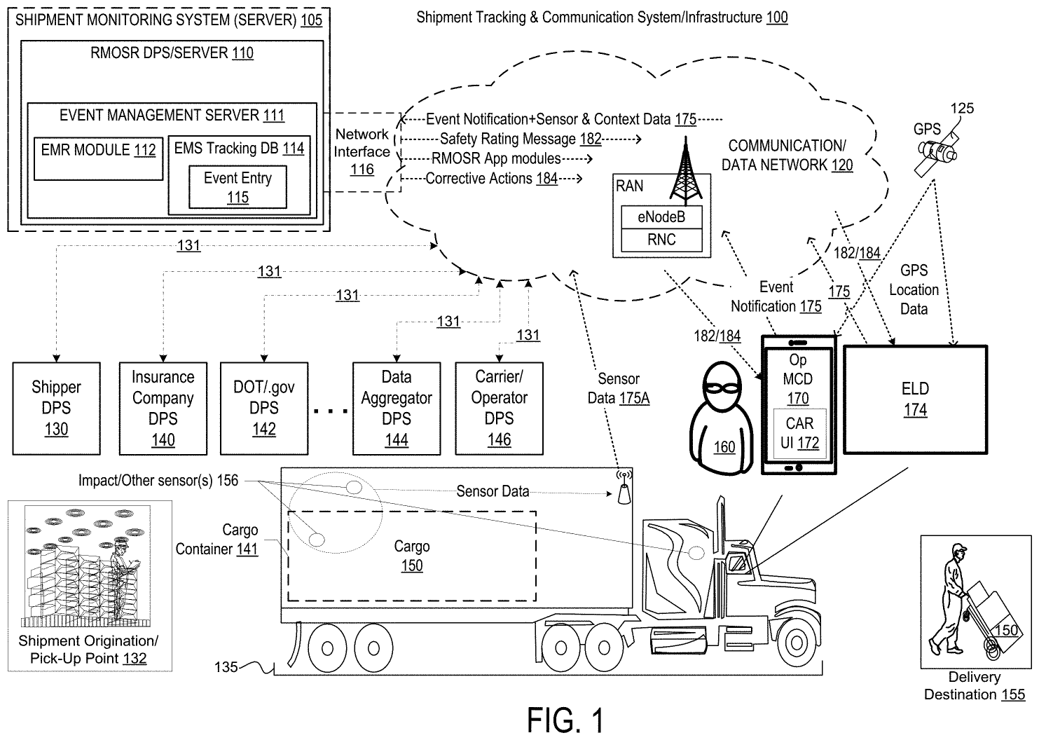

Turning now to the figures, FIG. 1 illustrates an example communication infrastructure (or shipment tracking communication network environment) 100 within which a RMOSR DPS 110 operates within a shipment monitoring system/server 105 to support the autonomous risk management and mitigation processes and driver/operator safety rating features of the disclosure. Communication infrastructure 100 generally includes distributed server data processing system (DPS) (105) within which is provided shipment monitoring/tracking system 105. The server DPS (105) generally operates as a remote shipment tracking server. RMOSR DPS 110 includes event management server (EMS) 111, which includes EMS response (EMR) module 112 and an associated event tracking database (DB) 114, also referred to herein as EMS DB 114. An example event entry 115 is shown within EMS DB 114. EMR module 112 executes to configure EMS 111 to perform the server-level event response features described herein, including, but not limited to generating and transmitting a corrective action notification to the driver's mobile communication device. For simplicity, because the features of EMS 111 are integrated within RMOSR DPS 110, all features of EMS 111 are described as being a feature performed by RMOSR DPS 110.

Communication infrastructure 100 also includes communication/data network 120. Communication/data network 120 includes a plurality of communication devices and subnetworks that enable voice, data, and other forms of communication between two or more entities that connect to communication/data network 120. Communication/data network 120 supports transmission of wirelessly communicated signals via intermediary receiving devices, such as antennas, network nodes, such as evolution Node B (eNodeB), and access points. Communication/data network 120 can include cloud storage for storing relevant carrier and shipping data and other historical data, including event reporting data, as one example. Shipment tracking server 105 and/or RMOSR DPS 110 communicatively connects with other devices over communication/data network 120 via network interface 116, which is a part of a communication subsystem of RMOSR DPS 110. Network interface 116 (and more generally communication subsystem) enables communication of VOD data, including event reports and notifications, location signals and other data and/or information between RMOSR DPS 110 and other devices. In one embodiment, shipment monitoring server 105 facilitates or supports download of a shipment tracking application onto driver/operator MCDs to enable local driver/operator MCDs (170) to interface with certain of the features and functionality supported/provided by the shipment tracking system. Communication infrastructure 100 further includes global positioning system (GPS) satellite 125 as one methodology utilized to identify/determine a current geographical location of a shipment-related entity, as described herein. Communication infrastructure 100 includes a communication link 131 to shipper DPS 130, which also monitors shipment of cargo 150 from shipment origination point 132. The cargo (or shipment) 150 is transported to a delivery destination 155 via one or more shipping routes. Communication infrastructure 100 enables efficient communication with operators and supports the monitoring and tracking of the various shipment-related entities within a shipment group.

According to one embodiment, each shipment-related entity can be tracked via a localized location tracker/sensor. In one or more embodiments, driver/operator MCD 170 can rely on cell tower triangulation for location detection, in addition to or in place of GPS-based location detection. As presented, the shipment-related entities include cargo 150, being transported in cargo container 141 placed inside tractor-trailer 135, which is driven by driver/operator 160, who has operator mobile communication device (MCD) 170. In the illustrated embodiment, each shipment-related entity is equipped various sensors 156, including, but not limited to impact sensors (156), which detect sudden, negative changes in velocity that correlates to the vessel being in a collision with another object (i.e., an impact). In one embodiment, impact sensors 156 transmits the detected impact data to a wireless transmitter, which communicates the impact data to EMS 111 via communication network 120 (potentially using driver/operator MCD as an intermediary communication device). In one embodiment, EMS 111 forwards impact data to RMOSR DPS 110 for driver safety calculations and/or corrective action assignment. In an alternate embodiment, the impact data can be transmitted from sensors or on-vehicle data aggregators directly to RMOSR DPS 110, which performs the driver/operator's safety level evaluation and updating of VOD data, etc. In one embodiment, EMS 111 and/or RMOSR DPS 110 responds to this automated notification of a potential event by instantiating a communication with the driver/operator MCD 170 to obtain additional details about what is locally occurring or what has occurred to trigger the impact sensors. Additional features of this automated response process are provided in the below description of the disclosure.

Communication infrastructure 100 includes a plurality of user DPSs, including but not limited to, shipper DPS 130, insurance company DPS 140, DOT or other government DPS 142, data aggregator DPS 144, Operator DPS 146, each connected to RMOSR DPS 110 via network one or more of the respective network links 131. RMOSR DPS 110 includes network interface 116 to support communication and data exchange with these various second electronic devices. As an example, network interface 116 receives event notification and sensor and context data 175. Network interface 116 enables transmission of safety rating message 182 and corrective actions 184 to at least the driver/operator MCD 170 and/or ELD 174. In one embodiment RMOSR application module (App) can be downloaded to operator MCD 170 and activated thereon.

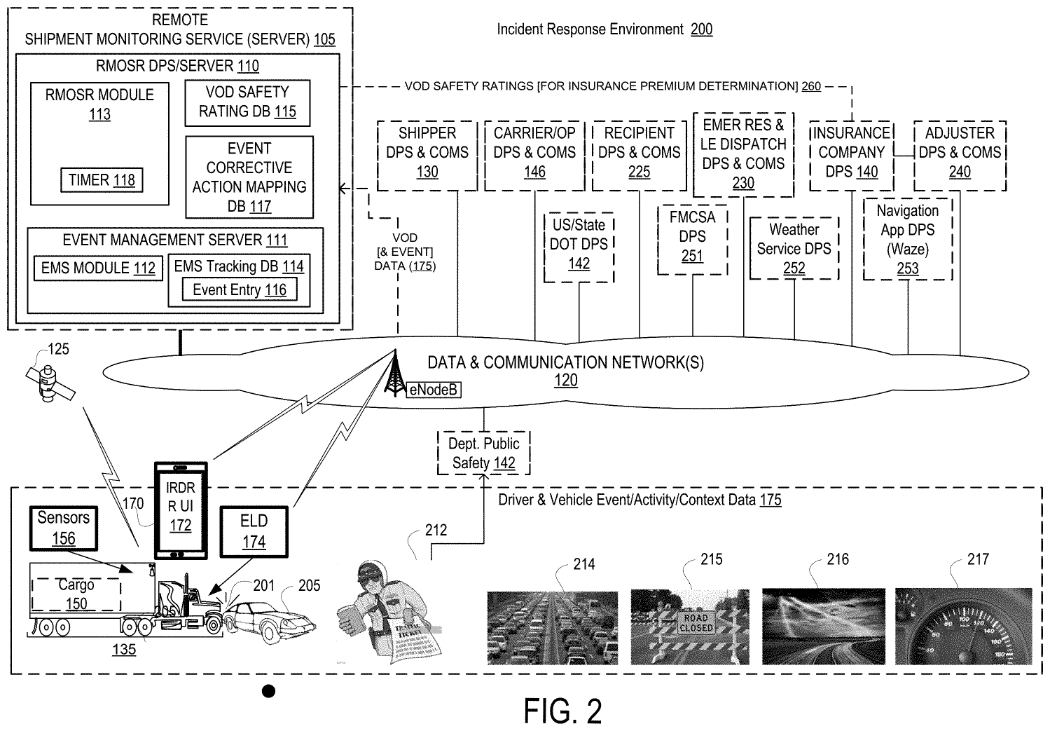

FIG. 2 illustrates an example event tracking and response environment 200 having a distributed network of interconnect devices that provide vehicle, operator, and driver (VOD) data utilized to track driving behavior, report occurrences of events involving the vehicle and/or driver, and autonomously generate and update VOD safety ratings utilized in determining insurance premiums, according to one or more embodiments. Incident tracking and response environment 200 presents an event 201 that triggers functions of both the RMOSR DPS 110 and EMS 111, as well as features implemented by and/or on the driver/operator MCD 170 and ELD 174. These features can involve communication with one or more relevant parties, based on the nature and/or severity of the particular event 201 or condition encountered by the driver or vehicle. Beginning at the bottom left of the figure, event response environment 200 presents a collision (event 201) between driver/operator-controlled vehicle (tractor-trailer) 135, driven by driver/operator 160 (FIG. 1), and a third party vehicle 205. A law enforcement (LE) personnel 212 is also presented issuing a ticket to the driver/operator 160. The collision and subsequent, contemporaneous activity, interactivity, and communication exchanged between the different people is hereinafter collectively referred to as an event. It is appreciated that other emergency response personnel may also arrive on the scene, and the presentation herein of LE personnel 212 is not meant to be limiting, but to instead cover those individuals as well.

In addition to the detection and recording, by on-board sensors, of the impact of the collision, additional relevant contextual information can also be captured by other sensors 156 embedded within vehicle 135 including sensors 156 that may be placed with the cargo, within the vehicle itself, or embedded within the ELD 174 or driver/operator MCD 170. Contextual data can include traffic conditions 214, road conditions 215, weather conditions 216, and speed of travel 217. These and other information are provided to RMOSR DPS 110 as VOD data, which includes event data and relevant contextual information related to the event data. In one or more embodiments, additional network-based resources are also provided to add contextual data to the event data collected. These additional network-based resources are provided via US and local state department of transportation data processing system (DPS) 142, FMCSA DPS 251, weather service DPS 252, and navigation app DPS 253, among others. According to one aspect, insurance company DPS 140 communicatively connects with RMOSR DPS 110 to access VOD safety ratings 260 used in insurance premium determinations.

According to one or more embodiments, the VOD data is collected from a plurality of different sources from among: (i) in-vehicle sensors collecting data of real-time vehicle operations, movement, and maneuvering; (ii) an event report (entered by a driver, police office, insurance adjuster, et al.) involving an operator vehicle and/or driver; (iii) a police report that references the operator vehicle and/or driver; (iv) contextual data corresponding to a time of a reported event, including weather/climatic conditions, road conditions and detours, et al.; (v) information from a navigation application (e.g., Waze™); (vi) a governmental record of one or more of the operator, driver, and/or vehicle, including a driving record of the driver of the vehicle; and (vii) third party provided information related to a safety of a vehicle (e.g., OEM published vehicle data, recalls), a driver and/or an operator. The in-vehicle sensors can be added to (or provided within) the vehicle by the OEM and/or can be added/embedded in the vehicle post manufacture, using off-the-shelf components. The governmental record can include one or more of department of transportation (DOT) information and federal motor carrier safety administration (FMCSA) records associated with the driver, operator and/or vehicle. According to one embodiment, the FMCSA data includes drug testing data of the drivers, in addition to the other data.

Additionally, in one or more embodiments, the features of the RMOSR data processing system (DPS) is implemented via/within a shipment monitoring and tracking system that tracks and presents a plurality of cargo-carrying vehicles across one or more geographical areas via the operator vehicles. The RMOSR DPS is communicatively coupled to a distributed network. A plurality of VOD data collection devices that provide the VOD data to the RMOSR computing system is also communicatively connected to the distributed network. The data collection devices include an in-vehicle data aggregator, such as an operator mobile communication device (MCD), an electronic logging device (ELD), and/or a local data aggregator, communicatively coupled to one or more in-vehicle sensors and environment/ambient sensors. In one embodiment, an app is deployed on the driver/operator MCD and/or the ELD, where the app is executed by the device's controller/processor to configure the device to perform the various localize processes for risk mitigation and improving the safety rating of the driver and/or vehicle. In one embodiment, the sensors provided within the vehicle are able to monitor and report (to the local data aggregator or ELD) data related to speeding, cornering, breaking, and measurable driver actions/errors/omissions, such as swerving, lane departures, or lane changes without signaling, and failing to break (or slow down) during inclement weather, etc. Other environment sensors can report the weather condition around the vehicle, which may be different from the reported weather data for the geographical area received from a connected weather service computer. The localized vehicle data are transmitted via the network connection to an aggregation computer, such as the shipment monitoring service computer, in one embodiment.

According to one aspect, the ELD 174 includes a memory having stored thereon one or more event tracking applications that support recording of local data associated with a safety-related event affecting one or both of the vehicle and/or the driver. The safety-related events can include, but are not limited to including, (i) speeding, (ii) cornering, (iii) breaking, (iv) impact detection, and other measurable data associated with the geographic location, such as road conditions and localized weather conditions. Also stored on the memory is a safety response module that enables safety messages or notifications to be communicated to the driver by the operator and/or a background shipment monitoring system. The ELD includes a display device and at least one an input/output device, which can be integrated into the display as a touchscreen. The ELD includes a network interface enabling connection to one or more communication networks. The ELD also includes a processor communicatively coupled to the network interface, the display device, the at least one I/O device, and the memory. The processor executes the various applications to configure the ELD to: receive the detected sensor data; communicate the sensor data to a remote data aggregator service associated with an RMOSR DPS; and receive corrective action notifications and present the notifications on the display of the ELD. In one embodiment, the processor is also configured to enable the driver to complete the corrective action via the ELD, by accessing content provided via a remote database, and then report a completion of the corrective action back to an RMOSR DPS. In one embodiment, several of the above-described functions and/or processes are integrated into the core functions of the ELD, which also automates the recording (collection and reporting) of commercial driving hours, as Hours of Service (HOS), to make sure the driver adheres to the legal limits. According to one embodiment, the safety response features of the ELD can also be provided via a driver MCD. The MCD can be one of a smartphone, tablet, or other portable computing device having a unique subscriber identifier (ID).

In one or more embodiments, separate, different services/devices collect specific ones of the local data and then forwards that information to the shipment monitoring system for use by the RMOSR computing system. Additionally, contextual data is also collected by other sensors, not local to the vehicle, and the contextual data is then provided as real time data to the RMOSR computing system for aggregation with the in-vehicle collected data. As an example, information related to weather conditions, road conditions (presence of road work or detours), work zones, accidents, and detours, traffic delays/slowdowns, etc., can be received from server computers of secondary applications/services, such as data from Waze™ or Google Mapsυ services.

The top right section of event response environment 200 presents a series of data processing systems and communication devices for personnel of the relevant parties who would have an interest in receiving event reports and/or notification about the occurrence of events involving one or more of the vehicle, operator, and/or driver. Additionally, an insurance company DPS receives VOD safety ratings that are used for insurability determinations and insurance premium determination, in one or more embodiments. It is appreciated that the communication of the event data and VOD safety ratings, etc., occurs via these network-connected devices. For clarity, the devices are described based on the specific relevant party with whom the device is associated.

According to the illustrative embodiment, the event reports and/or notifications can be communicated via communication network 120 to select DPSs and communication devices of shipper 130, operator and/or carrier 220, cargo recipient 225, insurance company 230 and insurance adjuster 235. Incident data and notification is also communicated to emergency response and/or law enforcement dispatcher 240. The DPS and/or communication device (130, 146, 225, 230, 140, 240) of each relevant party is communicatively connected, via communication network 120, to EMS 111 associated with shipment monitoring service 105. According to one embodiment, the early notification is received at one of adjuster DPS 235 or insurance company DPS 230 from EMS 111. This early notification of the event 201 enables a local insurance adjuster to arrive on the scene of the event contemporaneously with the occurrence of the event. Additionally, instructions and directives can also be provided to driver/operator MCD 170 from RMOSR DPS 110 and specifically EMS 111 to mitigate the extent of the liability on the driver/operator, in one or more embodiments.

Referring now to FIG. 3, with ongoing reference to FIG. 2. FIG. 3 is a block diagram illustrating an example RMOSR DPS 110 (e.g., a server) that operates to provide the various features for autonomous risk management, with VOD tracking and driver/operator safety rating generation and updating, in accordance with one or more embodiments. RMOSR DPS 110 can be one server within a cluster of servers, where the servers can be co-located in a single location and/or geographically dispersed over a plurality of locations in a distributed system. In other embodiments, RMOSR DPS 110 can be any electronic device such as, but not limited to, a desktop computer, notebook computer, or a single server. Additionally, in one embodiment, RMOSR DPS 110 can be implemented as a virtual machine sharing hardware resources of a physical server. In one embodiment, RMOSR DPS 110 operates as a networked computing device providing a cloud infrastructure that supports implementation of a carrier and shipper interfacing and shipment tracking (CSIST) framework. Generally, RMOSR DPS 110 can operate as both a shipment and event data aggregator and/or a shipment monitoring center computer. As a data aggregator, DPS 110 receives information from shipment-related entities as well as third party computers and in-the-field sensors to enable collection of a variety of types of data related to the shipment and events involving the shipment and/or the driver, operator and/or shipping vehicle. As a monitoring center computer, RMOSR DPS 110 can be configured with additional software and firmware modules and components for receiving data, generating notifications, and responding to detected conditions within a shipment monitoring environment. For purposes of this disclosure, RMOSR DPS 110 includes the functionality of EMS 111 and the described features of EMS 111 can be assumed to be included within the features of RMOSR DPS 110. It is appreciated that, as shown within FIGS. 2 and 3, RMOSR DPS 110 can simply be any DPS equipped with RMOSR module 113 and EMS module 112 and access to corresponding VOD safety rating DB 115 and EMS event tracking DB 114. Hereinafter, RMOSR DPS 110 shall be referred to simply as DPS 110.

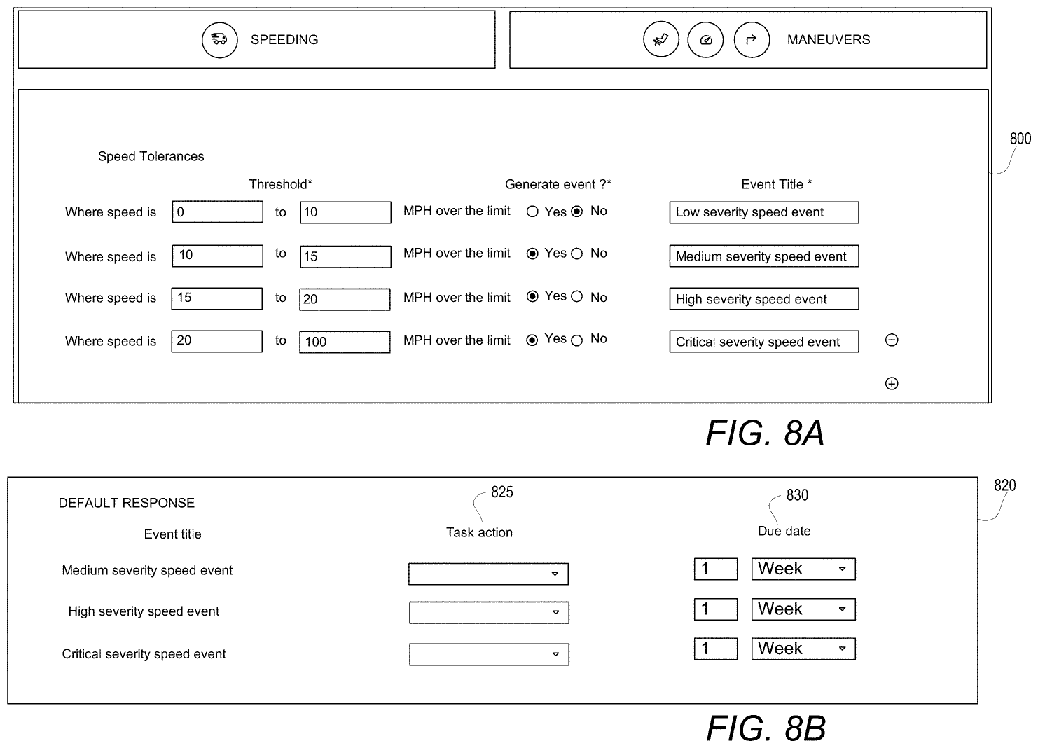

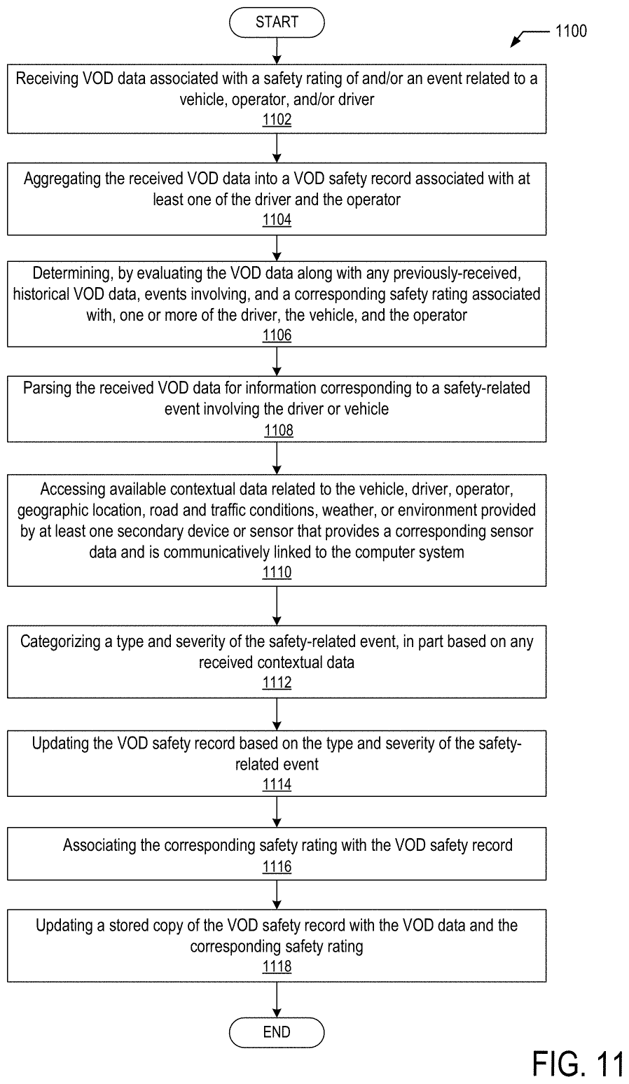

Example DPS 110 includes at least one processor, and potentially a plurality of processors, generally referenced hereinafter as central processing unit (CPU) 305. CPU 305 is coupled to system memory 310, non-volatile storage 320, and input/output (I/O) controllers 350 via system interconnect 315. System interconnect 315 can be interchangeably referred to as a system bus, in one or more embodiments. One or more software and/or firmware modules can be loaded into system memory 310 (from storage 320 or other source) during operation of DPS 110. Specifically, in the illustrative embodiment, system memory 310 is shown having therein a plurality of software/firmware modules, including firmware (F/W), basic input/output system (BIOS), operating system (OS), and application(s). Additionally, system memory 310 includes EMS module 112, RMOSR module 113, and communication module 316. While shown as separate components, EMS module 112 and RMOSR module 113 can, in alternate embodiments, be provided as a single combined module or within one of the applications and/or as an executable module within F/W, for example. RMOSR module 113 includes operator management graphical user interface (GUI) generation module 317 and operator insurability GUI module 318. According to one aspect, operator management GUI generation module 317 provides a series of operator GUIs (see FIGS. 7, 8A-8B, and 9) that enable the operator to receive an overview of and manage the safety aspects of the drivers and vehicles managed by the operator. According to another aspect, operator insurability GUI module 318 provides one or more insurance company GUIs per operator (see FIG. 10) that presents the insurance company with a quick overview of the safety rating of the operator and the insurability of the operator based on historical tracking of safety habits/behavior and insurance-related events of the drivers and vehicles managed by the operator. Each module also provides separate, secure access portals for the operator's device and the insurance company computers, respectively, with safety and event data presented at a granularity of the individual driver, the individual vehicle, and/or the operator. The software and/or firmware modules within system memory 310 enable DPS 110 to provide varying features and functionality when their corresponding program code is executed by CPU 305 or by secondary processing devices (not specifically shown) within DPS 110.

Local storage 320 stores a local copy of EMS event tracking DB 114, which is a repository of data related to the events reported by one or more driver/operator MCDs or ELDs within the larger shipping network. DB 114 includes a plurality of event entries, each tagged with a specific unique event ID. Portions of example event entry 322 is illustrated. As shown, event entry 322 includes the following data/information, without limitation: event type 324, Incident ID 325, details entered by operator 326, images captured by operator and others 323, audio files 328, notifications 329, time and location data 331, operator ID 332, and relevant party contacts 330. Remote cloud DB 380 includes remote copy of event tracking database 114″.

Additionally or alternatively, local storage 320 stores a local copy of VOD safety rating (SR) DB 115, which is a repository of data related to the insurability of a vehicle, operator and/or driver based on real-time and historical data and contextual data obtained from one or more secondary devices and sensors associated with the environmental conditions, road conditions, law enforcement interventions, driver/operator information, and vehicle data (e.g., collected from driver/operator MCDs or ELDs or locally placed sensors). VOD SR DB 115 includes a plurality of entries, each tagged with a specific unique ID associated with the driver/operator being tracked. Examples of information that can be maintained within example VOD safety record 340 are provided. As shown, VOD safety record 340 includes the following data/information, without limitation: driver/operator unique ID 341, event type 342, event details 343 entered by operator or retrieved contemporaneously from other sources, liability cost 344 to one or more insurance companies by the driver/operator, contextual data 345 associated with the recorded events (e.g., weather conditions, road conditions, speed, etc.), time, date, location data 346, corrective actions 347 communicated to the driver/operator and/or completed by the driver/operator. Additionally, VOD safety rating DB 115 maintains a current VOD safety rating 348 and optionally includes an insurability rating value 349, which may be in terms of dollar amounts or other measurement method. Remote cloud DB 380 also includes remote copy of VOD safety rating DB 115″.

According to one or more embodiments, one or more of VOD safety rating 348 and/or insurability rating value 349 includes driver/operator/vehicle insurance risk information, which includes historical information linking the particular driver, operator, and/or vehicle to a risk factor (e.g., cost to shipper or insured) that is, in part, based on the number of events reported over a period of time (e.g., from a start of event tracking by EMS 111).

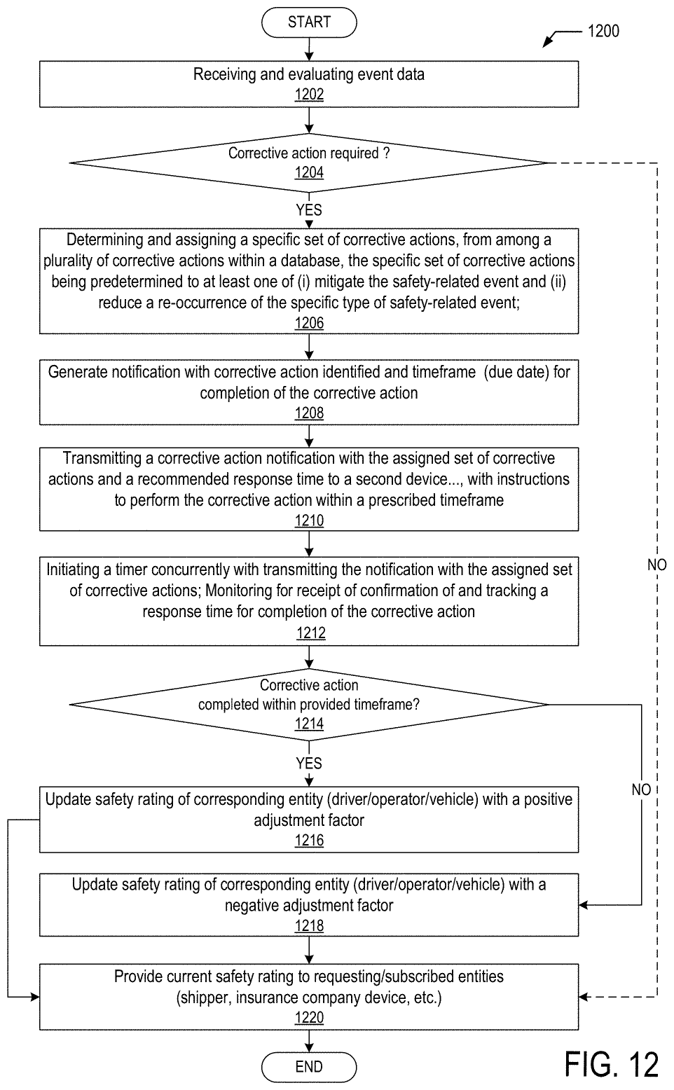

Referring again to the component makeup of DPS 110, DPS 110 includes I/O controllers 350, which support connection by and processing of signals from one or more connected input device(s). I/O controllers 350 also support connection with and forwarding of output signals to one or more connected output devices. I/O controllers 350 can also provide a device interface to which one or more removable storage device(s) (RSD(s)) 352 can be received. In one or more embodiments, RSD 352 is a non-transitory computer program product or computer readable storage device. In accordance with one embodiment, the functional modules (e.g., RMOSR module 113 and EMS module 112) described herein and the various aspects of the disclosure can be provided as a computer program product. The computer program product includes one or more RSDs 352 as a computer readable storage medium on which is stored program code of the respective modules 112 and 113. When executed by a processor (e.g., CPU 305), the program code of RMOSR module 113 causes the processor to implement the VOD safety rating analysis and associated functions described herein, including, but not limited to, the features illustrated within methods 1100-1200 of FIGS. 11-12, which are described below.

DPS 110 further includes a communication subsystem 360 that includes network interface device (NID) 361 and transceiver 362, which enables DPS 110 and/or components within DPS 110 to communicate and/or interface with other devices, services, and components that are located external to DPS 110 via direct connections and/or over a network. In one or more embodiments, DPS 110 connects to remote database (DB) 380, via external communication network(s) 120, using one or more communication protocols. Remote DB 380 can be a cloud storage, in one embodiment, and can include a remote, secure copy of event tracking repository 114 and a remote, secure copy of VOD safety rating DB 115. For purposes of discussion, communication network 120 is indicated as a single collective component for simplicity. However, it is appreciated that communication network 120 can comprise one or more direct connections to other devices as well as a more complex set of interconnections as can exist within a wide area network, such as the Internet.

Communication subsystem 360 also includes or supports operator access portal 363 and insurance company access portal 364. These portals enable external access by the operator device 146 and the insurance company computer 140, respectively, to the safety ratings and insurance-related events that are tracked and presented within GUIs at the operator level for each registered operator. A unique operator name and/or identifier (ID) is assigned to each registered operator, and the unique name or ID is used by the operator for secure access to operator-specific dashboard of data for monitoring and managing the drivers and vehicles within the operator's fleet.

As one aspect of the disclosure, RMOSR module 113 includes program code that are processed by/on CPU 305 to configure DPS 110 to performs functions provided by the disclosure. DPS 110 is incorporated into more general shipment monitoring system 100 to provide server-level VOD safety rating and other associated functionality presented herein. Accordingly, a DPS 110 is provided that includes a communication subsystem 360 and a memory 310 having stored thereon a RMOSR module 113 with program code for determining and assigning a safety and insurability rating to one or more of a driver, an operator, and a commercial vehicle, based on collected real-time data and historical data.

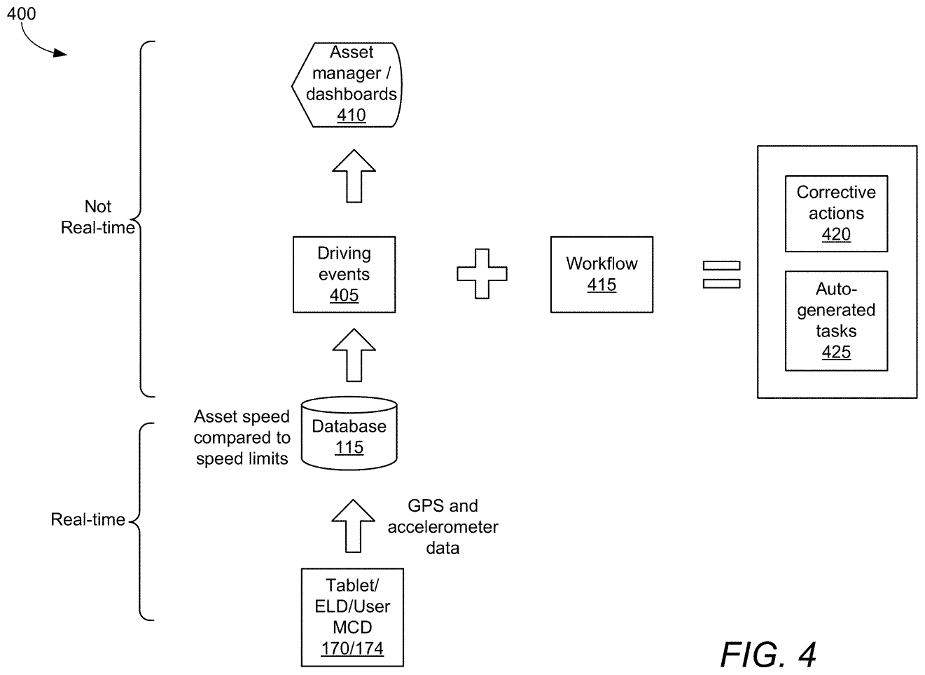

FIG. 4 illustrates an example workflow 400 for implementing certain of the features of the disclosure, using a combination of real-time information gathering and non real-time presentation of relevant historical data and information by the RMOSR DPS, according to one or more embodiments. The specific example of FIG. 4 depicts a workflow 400 for tracking and responding to a measured speed of the vehicle. Real time input date is captured by a local (in-vehicle) device 170/174, such as the driver/operator MCD or ELD, using locally-obtained accelerometer and GPS data. This information is provided to the VOD SR DB 115, where RMOSR DPS 110 processes the data as a driving event 405 that is provided for incorporation into and display on an asset manager's computer dashboard 410 for viewing by operator. The captured event data is further processed within the RMOSR workflow processing 415 to identify any corrective actions 420 and/or auto-generated tasks 425 that should be forwarded to the driver/operator. For example, if the driver is speeding, a notification to reduce speed and follow the posted speed limits can be the corrective action identified. Additionally, the auto-generated tasks may include taking a driving safety course within the next 3 months.

Returning to FIG. 3, the DPS 110 also includes at least one processor 305 communicatively coupled to the communication subsystem 360 and to the memory 310. The at least one processor 305 processes the program code for the RMOSR module 113, which configures the DPS 110 to receive, from at least one network-connected, second electronic device (e.g., MCD 170 or sensors 156 or any of third party DPSs 250-253) via the communication subsystem 360, a plurality of vehicle, operator, and/or driver (VOD) data associated with events involving, and a respective safety rating of, the vehicle, operator and/or driver. The DPS 110 is configured to aggregate the received VOD data into a VOD safety record 340 associated with at least one of the driver and the operator and determine, by evaluating the VOD data along with any previously-received, historical VOD data, a corresponding safety rating 348 associated with one or more of the driver and the operator. The DPS 110 is configured to associate the corresponding safety rating 348 with the VOD safety record 340 and update a stored copy of the VOD safety record 340 with the VOD data and the corresponding safety rating. The VOD safety record 340 is accessible via a network portal to at least one insurance company computer 230 (FIG. 2) for use during evaluation of insurability and premium cost for insuring one or more of the vehicle, the operator, or the driver. Processor execution of the RMOSR module 113 further configures the at least one processor 305 to perform the processes indicated as methods 1100-1420 depicted by FIGS. 11 and 12, which are described in greater detail below.

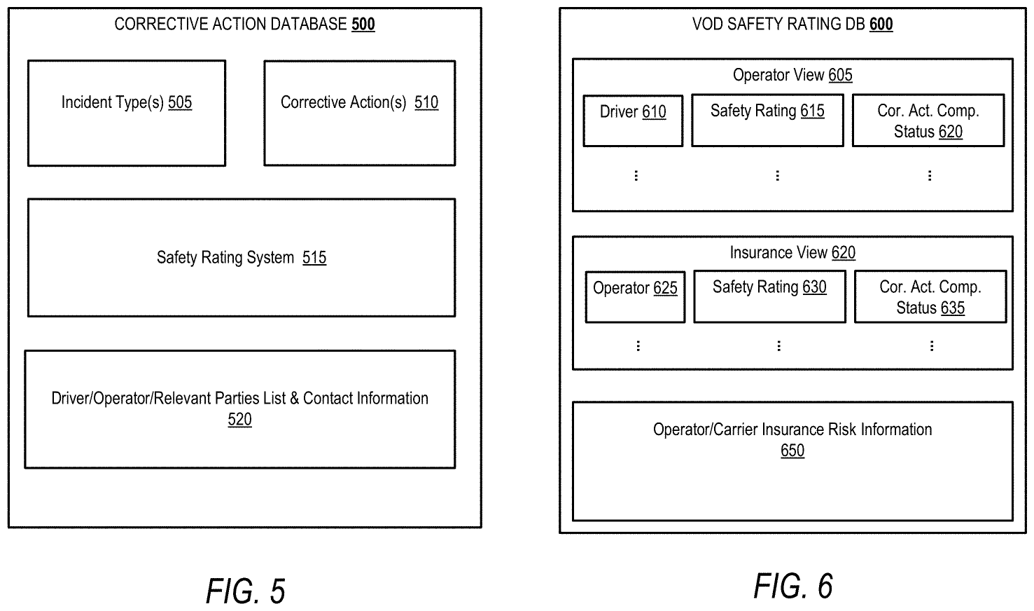

FIG. 5 presents an example corrective action database 500 that includes a plurality of different modules and data utilized by the RMOSR DPS 110 to perform the various features related to assigning and monitoring completion of corrective actions, as described herein, in accordance with one or more embodiments. Corrective action database 500 includes event types 505, a plurality of corrective actions 510, safety rating system 515, and relevant parties contact list 520.

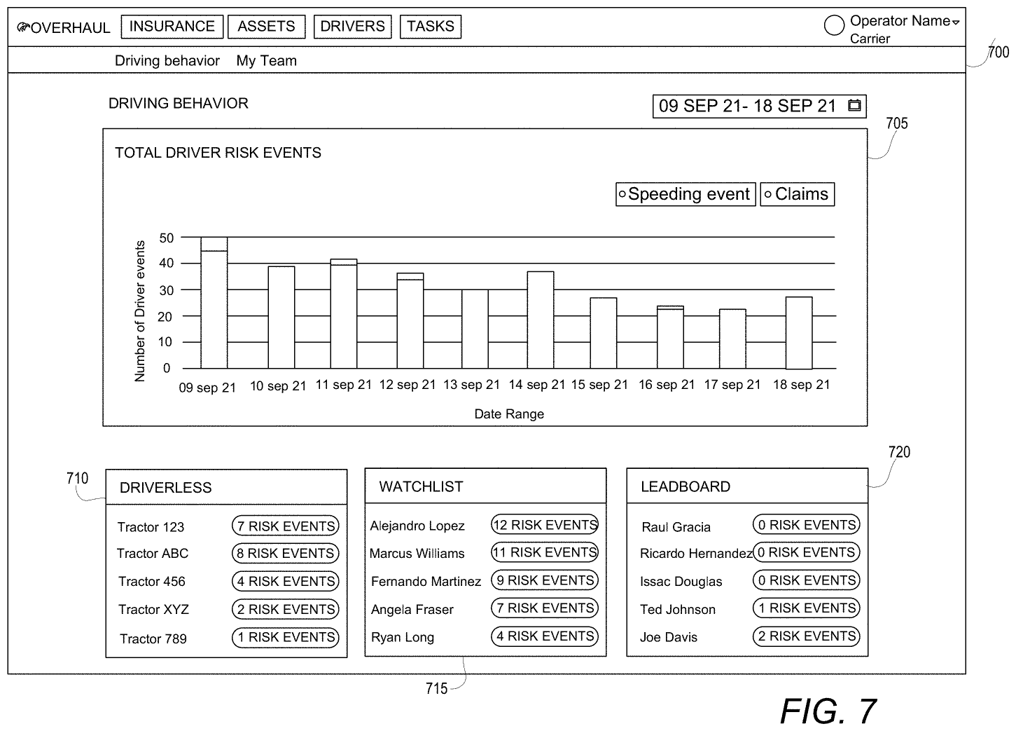

FIG. 6 presents example entries within a VOD safety rating database 600 that presents relevant details within an operator view 605 about each driver 610, including a safety rating 615 and corrective action completion status 620, in accordance with one or more embodiments. VOD safety rating database 600 also supports an insurance company view 620 than includes a listing of insured or to-be-insured operators 625, the associated safety rating 630 of each of the operators, and the corrective action completion status 635 for the operator's drivers. VOD safety rating database 600 also includes operator and vehicle insurance risk information 650, which includes historical information related to the insurance risk of the operator and/or the vehicle.

One additional aspect of the disclosure involves the RMOSR DPS 110 maintaining a library of different course materials (e.g., videos or printed information), links to specific secondary resources, and information about in-person courses, etc. that can each corresponding to specific ones of the different types of events that require corrective actions. The specific corrective action associated with the event (from the database) is identified and provided within the notification, and direct or link access to the course material is provided with the notification to the driver via a direct link or provided address. The course material may be a suggestion of one or more than one different material that the driver can select from, and each different course material may have a different weight (i.e., adjustment value) of safety rating adjustment. Accordingly, as one example, a driver can receive a notification presenting two or more corrective actions, each having a corresponding rate adjustment factor. The driver can elect to complete only one or multiple of the provided corrective actions, and the driver receives a combined larger positive rating adjustment if he completes two or more of the corrective actions.

The disclosure presents several different aspects, with various processes performed by different network-connected devices. According to a first aspect of the disclosure, an RMOSR computing system processes program code of an RMOSR application, which configures the computing system to perform the processes of: receiving, from at least one network-connected, second electronic device, a plurality of vehicle, operator, and/or driver (VOD) data associated with a safety rating; aggregating the received VOD data into a VOD safety record associated with one or both of the driver and the operator; determining, by evaluating the VOD data, a corresponding safety rating associated with one or more of the driver and the operator; and storing/associating the safety rating with the VOD record. The method processes further includes, in response to receiving/detecting VOD data corresponding to a safety-related event involving the driver or vehicle: retrieving any available contextual data related to the vehicle, driver, operator, geographic location, road and traffic conditions, weather, or environment; categorizing a type and severity of the safety-related event, in part based on any received contextual data; retrieving a specific set of corrective actions that is predetermined to mitigate the safety-related event or reduce a re-occurrence of the associated type of safety-related event; and transmitting a notification with the set of corrective actions to a second device associated with at least one of the operator, the driver, and the vehicle, with instructions for the operator and/or driver to perform the corrective action within a prescribed timeframe.

According to at least one embodiment, the evaluating of the VOD data includes matching the VOD data with pre-identified types of event data that are each correlated to specific safety metrics and associated thresholds utilized for evaluating driver and operator safety ratings. Each of a plurality of different safety ratings is correlated to an insurability rating that is assigned to the corresponding operator and/or driver and which is utilized to determine a cost of insurance provided to the operator by an insurance provider.

According to one or more embodiments, the method further includes: determining a negative adjustment factor to assign to an operator/driver safety rating in response to receipt of the VOD data identifying occurrence of the safety-related event; assigning and transmitting, within the corrective action notification, a specific time frame for the driver/operator to complete the corrective action; and monitoring for receipt of confirmation, within the assigned timeframe, that the driver/operator has completed the recommended corrective action. Further, the method includes, in response to the driver/operator completing the corrective action within the assigned time frame: reducing the (absolute value of the) negative adjustment factor from a first value to a second value that is less negative than the first value; adjusting an overall operator/driver safety rating to a first updated operator/driver safety rating by applying/adding the second value to a current operator/driver safety rating; and updating the driver/operator safety record to reflect the first updated operator/driver safety rating. Alternatively, in response to not receiving confirmation of completion by the operator/driver of the corrective action within the established time frame: incrementing the negative adjustment factor to a third value that is more negative than the first value; adjusting the overall operator/driver safety rating to a second updated operator/driver safety rating by applying/adding the third value to the current operator/driver safety rating; and updating the driver/operator safety record to reflect the second updated operator/driver safety rating. The method also includes: transmitting a notification of the adjustment to the operator/driver safety rating to at least the communication device of the operator; and in response to a request for current operator/driver/vehicle safety ratings by an insurance company, providing the updated, current operator/driver safety rating the a device of the requesting insurance company, wherein the insurance company device computes an insurance premium for the operator, driver and/or the vehicle, in part based on the current, updated operator/driver safety rating.

According to one or more embodiments, the relative value of the negative adjustment factor is correlated to the type of safety event reported. Additionally, the value can also correlate to or be adjusted based on a frequency of the occurrence of the similar type of safety event involving the same driver/operator/vehicle. According to one example, the value of the first adjustment factor is a first negative value that reduces the safety rating of the operator/driver, the third value is a larger negative value that further reduces the safety rating below that of the first value, while the second value can be one or (i) a smaller negative value than the first value or (ii) a positive value that provides an increase to the safety rating as a reward for timely completion by the operator/driver of the corrective action.

In one or more embodiments, the RMOSR computing system implements a more granular approach to adjusting the safety rating for each driver, based on the response time of the driver to complete the assigned corrective action. With these embodiments, a graduated scale of safety rating adjustment factors is provided, whereby the faster response time (e.g., within 60 minutes of transmitting the corrective action notification) is allocated a higher positive (or lower negative) adjustment factor. Correspondingly, a slower response time (e.g., 24 h hours) for completing the corrective action is allocated a lower positive (or higher negative) adjustment factor and an even more negative adjustment factor if the response time is longer than the recommended response time. The time at which the corrective action is first accepted by the driver is also recorded and can be factored into the overall determination of response time, as the driver may be focused on driving and is thus not able to pay attention to his device or tackle the corrective action for a time period after the notification is received on the driver's MCD or ELD. Driver notification can be provided via a text message, direct notification to an installed app, an email, or populating within a driver's electronic calendar.

According to one or more embodiments, both a frequency and level of departure from safety practices are measured. Thus, rather than simply recording events of speeding, the RMOSR DPS tracks the number of miles above the speed limit and/or relative speed during adverse conditions (e.g., rain, sleet, snow) that requires a reduction of vehicle speed below the posted limits. The adjustment factor is then correlated to the number of miles above speeding. Also, the frequency of occurrence of a particular safety-related event is also tracked and used to determine the value of the adjustment factor. For example, a driver who speeds only once would receive a small negative adjustment (or no negative adjustment, if corrective action is timely taken) than another driver or the same driver who speeds on multiple occasions. Adding the frequency layer also permits for certain tolerances whereby a single event of speeding may trigger only a warning to the driver to not speed, but does not trigger a reduction in the driver's safety rating. As another example, speeding that is only 5 miles above the posted speed limit may fall within the tolerance permitted that does not trigger a reduction in the driver's safety rating. However, the driver may be subject to a conversation by the operator or other non-punitive response to alert the driver that the infraction, though minor, was noticed and reported.

According to one embodiment, in addition to corrective actions, the information provided by the RMOSR DPS may be information that can help the driver avoid being involved in a catastrophic even or allow the driver to render assistance to others. For example, the RMOSR DPS may inform the driver to adjust the vehicle speed or change route based on one or more data inputs received from a third-party data provider, such as construction zone information, inclement weather notification, etc. The computer can also provide a BOLO (be on the lookout for) alert to the driver for an event occurring in the vicinity of the driver. The response by the driver to these RMOSR DPS directives or suggestions or request for action can also result in an increase in the driver's safety rating, as the driver demonstrates a willingness to be responsive to received action requests that is provided to improve the safety of the driver, vehicle, cargo, and others.

According to one or more embodiments, before retrieving the specific set of corrective actions, the method includes: evaluating whether the type of safety event identifies a correctable issue with the driver, operator and/or vehicle. Then, the method includes: in response to the type of safety event identifying a correctable issue, retrieving a subscriber identifier (ID) (e.g., phone number or network ID) of the operator/driver/vehicle communication device; retrieving information about an appropriate corrective action for the operator/driver to perform; associating a time frame for the operator/driver to complete the corrective action; and transmitting, to the operator/driver communication device, a notification that includes the corrective action and time frame for completing the corrective action.

According to another aspect of the disclosure, a computer-based system of tracking drivers and vehicles is disclosed whereby an operator DPS is able to track the drivers and vehicles owned and/or managed by the operator, enabling the operator to autonomously implement a culture of safety among employed drivers and track driver behavior. As introduced in FIG. 3, an operator access portal allows direct access by an operator device or computer to historical events data and other safety related data of the vehicles and drivers managed by the operator. The operator is one that is registered with the RMOSR DPS. The method includes detecting a login by an operator device to the RMOSR DPS via an operator accessible portal and identifying an operator ID associated with the login. The method includes retrieving, from the VOD safety DB, a plurality of operator related VOD event data and VOD safety ratings corresponding to one or more drivers and one or more vehicles managed by an operator associated with the operator ID. The method includes presenting, within a series of graphical user interfaces, formatted data representing a historical view of events associated with at least one of the one or more drivers and the one or more vehicles. The method includes presenting, within at least one graphical user interface (GUI), an overview of an insurability rating of at least one of the operator, the one or more drivers, and the one or more vehicles.

In one or more additional aspects, the method includes generating and presenting a set of corrective action GUIs comprising a corrective action assigning GUI and a corrective action tracking GUI. In response to a selection of the corrective action assigning GUI, the method includes presenting a list of drivers and associated events that can require a corrective action. The method includes enabling operator selection of a specific corrective action from a plurality of pre-established corrective actions to assign to a selected driver and enabling operator selection of a due date for completing the corrective action. The method further includes automatically forwarding the corrective action with the due date to a device of the driver to whom the corrective action is assigned.

According to yet another related aspect, in response to selection of the corrective action tracking GUI, the method further includes generating and presenting a GUI with a select list of drivers to whom a corrective action has been previously assigned for completion and populating within the GUI a completion status of each corrective action assigned, including an indication of which corrective actions have not been completed by the assigned due date. The method includes activating a driver notification and correction protocol, which informs each driver who has not completed an assigned corrective action by the assigned due date of a penalty or other recourse action to be imposed on that driver.

FIG. 7 illustrates example operator dashboard (i.e., user interface window) 700 presented within a display of an operator device, such as a DPS, tracking driving behavior of a plurality of drivers managed by the operator, according to one or more embodiments. While described as an operator DPS, it is appreciated that the operator device used can be an electronic device with networking capabilities and a display device that would not necessarily be called a DPS. As presented within the example workflow diagram of FIG. 4, the operator's DPS receives, from the RMOSR DPS 110, driver and vehicle data associated with each driver and vehicle registered with the operator. The operator DPS outputs/displays a listing of each driver along with historical and current driver data for each driver, including the safety rating of the driver, corrective action(s) assigned, corrective action(s) completed, in-progress status for outstanding corrective actions. Thus, as shown by the specific example of FIG. 7, the driving behavior window 700 includes a driver risk events bar chart 705 showing a number of events of driver speeding detected over a 10-day period, as well as any insurance claims filed during that same period. Driving behavior window 700 also provides a vehicle focused list 710 that shows the number of risk events by vehicles. Driving behavior window 700 also provides a watchlist 715 for drivers who have had the largest number of risk events. The drivers presented in watchlist 715 can be selected based on the historical number of risk events by that driver or over a selected time frame, such as the 10 days presented within the risk events bar chart 705. Driving behavior window 700 also includes a leaderboard 720, which presents the drivers with the highest safety ratings or lowest number of risk events.

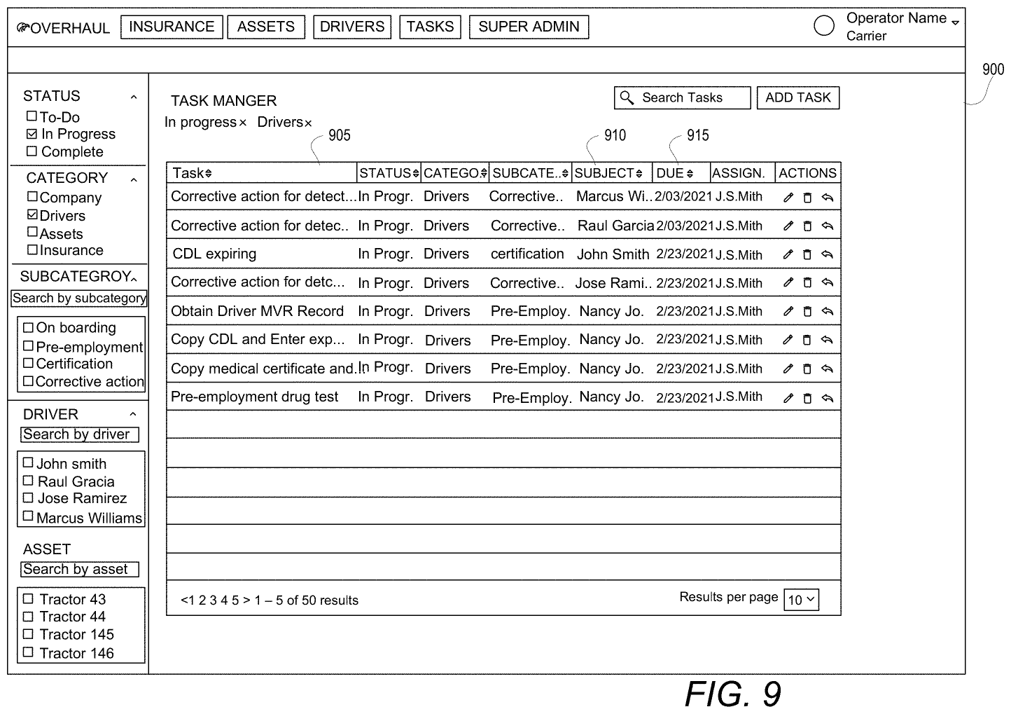

FIGS. 8A and 8B illustrate additional windows provided on the operator dashboard to track speeding events involving the fleet of vehicles owned or managed by the operator. In FIG. 8A. speed tolerances window 800 presents selectable (Yes/No) options 810 for whether to generate an event based on the number of miles per hour over the speed limit. The operator is able to select when to generate an event notification and provide a title for the type of event generated. In FIG. 8B, default response window 820 provides operator with a pull-down options for each of the speed ranges in FIG. 8A that the operator has tagged to trigger generation of an event. The task actions 825 are from a selectable list and each have a due data assigned within a due date column 830. Examples of task actions 825 can include transmitting a notification/message with a warning to the driver of the vehicle, monitoring the driver for other infractions, informing the driver that he/she cannot have any additional infractions within a set period of time, suspending or grounding the driver, requesting the driver complete a drivers safety course, assigning specific course (reading) material to the driver for completion, and terminating the driver for reckless driving, etc.

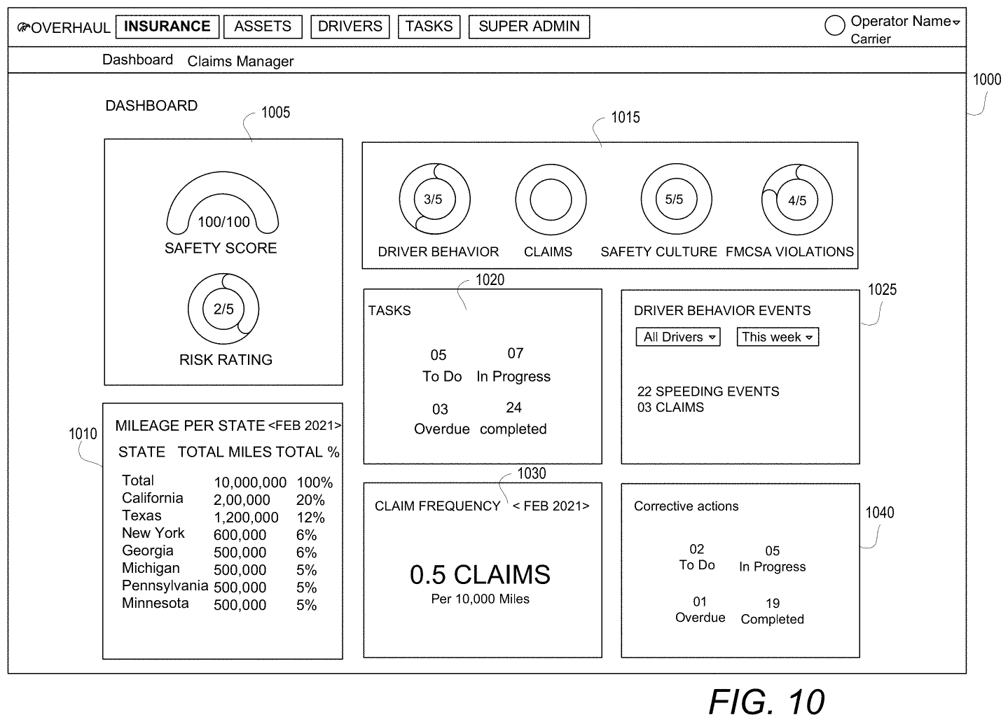

FIG. 9 provides a task manager widow 900 indicating a series of tasks 905 and corresponding drivers 910 with associated due dates 915 for completion. Notably, three of the first four tasks within series of tasks 905 are related to corrective action that have been assigned to the specific driver 910. Other tasks are administrative tasks that are to be completed to keep operator in compliance when onboarding new drivers or ensuring existing drivers have their requisite paperwork and licenses. Task manager window 900 also allows for selection of other features related to the management of the drivers within the control of the operator. The list of drivers within the pool are presented in a list that can be searchable using a search entry. Task manager window 900 also enables access to a list of all vehicles with accompanying data of relevance for tracking. Additionally, task manager widow 900 includes an insurance option that presents the operator with a full overview of the insurance on each vehicle and each driver being managed within the task manager application.

In one or more embodiment, selection of the driver opens a second window which provides other driver data, including events that require driver training, driver overall status, types of vehicle driver is approved to operate, the vehicle the driver is currently operating, etc. Within the main window, the drivers can be provided a relative ranking identified by the sequence in which the drivers are listed or by color coding, etc. In one embodiment, the ranking can be correlated to the safety rating, or vice-versa. Also, in one embodiment, the safety rating and/or ranking can be tied to a status for types of shipments the driver is approved to transport. The operator can then quickly select the correct driver based on safety ratings and relative ranking or status amongst the list of available drivers and the specific shipment or cargo the operator is being hired to transport.

To implement the culture of safety, the operator establishes a risk threshold that is programmed into the operator DPS. A notification is generated and outputted (transmitted to operator management/personnel) whenever a driver falls below the risk threshold. In one embodiment, the operator's DPS automatically forwards a corrective action to the driver MCD. The operator management is also notified of the transmission and provided automated updates of whether or not the driver completes the corrective action. The operator is thus able to directly address those drivers who fail to complete corrective actions within the allotted time frame and thus autonomously maintain a culture of safety within the operator's organization.

According to one or more embodiments, the operator is also able to establish a minimum safety score and provide specific criteria or safety thresholds for grounding a driver who is not achieving or falls below the minimum safety rating required. The driver can also be identified for grounding or being reprimanded or terminated when the driver is delinquent in completing corrective actions assigned, has more than a limit of events on his record within a time period (e.g., 3 accidents in the past 12 months), or otherwise falls below the established minimum threshold that will cause an increased in insurance premiums to the operator.

According to yet another aspect of the disclosure, and as introduced in FIG. 3, an access portal is provided to allow direct access by an insurance company computer to safety ratings and other data related to insurability of different operators registered with the RMOSR DPS. The method includes matching the VOD data with pre-identified types of event data that are each correlated to specific safety metrics having associated thresholds utilized for evaluating vehicle, driver and operator safety ratings. The method also includes correlating the driver and operator safety rating to an insurability rating that is assigned to the corresponding driver and/or operator, the insurability rating being utilized as an objective measure to determine a cost of insurance provided to the driver and/or operator by an insurance provider. The method further includes providing the insurability rating as accessible data within an insurance company portal accessible via the network by computer devices of insurance companies.

In one or more embodiments, the method further includes detecting a login by an insurance device to the RMOSR DPS via the insurance company portal and receiving an entry of an operator identifier associated with an operator being tracked by within the VOD safety rating DB. The method includes accessing the VOD safety records of the operator within the VOD safety rating DB. The method then includes generating and displaying a graphical user interface (GUI) presenting a set of formatted information comprising a VOD safety rating of the operator and a plurality of additional events and data utilized within a determination of the VOD safety rating that collectively provides a snapshot of the insurability of the operator.

FIG. 10 presents an example dashboard 1000 in which an overview of a VOD safety record for a particular operator is provided. The dashboard 1000 can be generated on a display device of an insurance company's computer or the computer of an insurance underwriter, where the computer is communicatively connected to the RMOSR DPS 110 via a network portal. Within dashboard 1000, a first block 1005 provides the operator's safety score and risk rating. A rightmost bottom block 1010 presents the mileage covered by the operator's vehicles by a top N states, where N=7 in the illustrative embodiment. A topmost block 1015 presents four components that are being monitored or tracked for use in computing the safety score and risk rating. These components include, but are not limited to only expressly including, driver behavior, claims made or paid, safety culture, and FMCSA violations. Dashboard 1000 further includes middle task block 1020 showing the completion status of various tasks assigned to the drivers or operator administrators. At the middle right, dashboard 1000 includes driver behavior events block 1025. The bottom two blocks include claim frequency block 1030 and corrective actions block 1035. Corrective actions block 1035 tracks the assigned corrective actions and identifies when an assigned corrective action has not been completed by the assigned dues date (i.e., is overdue), which negatively affects the safety score and risk rating for the operator. Each of the blocks, other than the first block, factor into the evaluation of an insurability and insurance premium rate to assign to an operator. The majority of the computation and determining of the safety score and risk rating, and ultimately the insurability is performed by RMOSR DPS 110, enabling a more objective analysis of insurability and assigned premiums.

Benefits derived from implementing the various features described herein include, but are not limited to, (i) dynamically identifying safe or higher rated drivers, (ii) providing more cost effective insurance premiums based on driving safety ratings to allow the safer drivers and/or operators employing good drivers to automatically pay less premium for insuring their vehicles, (iii) providing online accessible training for drivers involved in a safety-related event, (iv) tracking corrective behavior of drivers and enabling drivers to rehabilitate their ratings and take required training to make the drivers better, and (v) providing notification to responsible parties, such as operators and shippers, about drivers who are out of compliance with safety requirements and/or who fail to complete the required corrective actions. The disclosure implements/provides a pro-active risk-management system to prevent accidents and/or reduce financial liability or losses by educating and training drivers, enabling the drivers to increase and maintain their safety rating, which limits risk to the respective insurance companies. The system-generated safety rating, which incorporates contextual data, is then utilized to determine premium pricing per vehicle, driver, and/or operator. Additionally, the features of the disclosure enable digitization of all back-office work required by an insurance company to evaluate insurance ratings for their operators. The disclosure provides accurate, non-subjective, risk determination by insurance providers for operators being insured.

As some additional benefits, a claims manager is provided with quick access to data related to a safety-related event and is thus able to resolve claims quickly. When the operator is involved in litigation with a third party from an event involving the driver and/or vehicle, an operator is able to utilize the historical safety and training data to show that the drivers have been trained and have a high safety rating based on the features presented herein. This further reduces the likelihood that the driver can be portrayed as a bad driver who did not have proper training. Such portrayals are common during court proceedings, where drivers have no connection with an objective and tested risk mitigation system.

According to one embodiment, a Bluetooth tag is placed on the windshield of each truck to uniquely identify the vehicle and used to report when a specific vehicle has been involved in an accident. In one or more embodiments, a specific insurance application, e.g., the Claims Buddy™ app, is also installed on the ELD, which results in an increase in the speed of processing insurance claims. Importantly as well, with the implementation of the features of the present disclosure, the use of the legal system to vilify drivers in the hopes of a big settlement or damages award are substantially reduced.

FIGS. 11-12 are flow charts of various methods 1100 and 1200 performed by RMOSR DPS 110, according to a plurality of embodiments. The features described are performed by processing of program code from RMOSR module 113 by processor/CPU 305 (FIG. 3). The processing involves algorithms and code segments provided as components of RMOSR module 113. Certain aspects of the methods 1100/1200 include processing of event data and context data that are received from other devices and sensors via communication subsystem 360, as illustrated by FIGS. 1 and 2. And some or all of the methods 1100/1200 can also generate output data, reports, results, notifications, GUIs, and other output as described throughout the specification and illustrated by FIGS. 1-10.

Referring to FIG. 11, method 1100 begins at the start block and proceeds to block 1102, which provides receiving, from at least one network-connected, second electronic device via a communication subsystem of a risk management and operator safety rating (RMOSR) computer, a plurality of vehicle, operator, and/or driver (VOD) data associated with events involving and a respective safety rating of the vehicle, operator and/or driver. Method 1100 includes aggregating the received VOD data into a VOD safety record associated with at least one of the driver and the operator (block 1104). Method 1100 includes determining, by evaluating the VOD data along with any previously-received, historical VOD data, a corresponding safety rating associated with one or more of the driver and the operator (block 1106). Method 1100 includes parsing the received VOD data for information corresponding to a safety-related event involving the driver or vehicle (block 1108). Method 1100 includes accessing available contextual data related to the vehicle, driver, operator, geographic location, road and traffic conditions, weather, or environment provided by at least one secondary device or sensor that provides a corresponding sensor data and is communicatively linked to the DPS (block 1110). Method 1100 includes categorizing a type and severity of the safety-related event, in part based on any received contextual data (block 1112). Method 1100 includes updating the VOD safety record based on the type and severity of the safety-related event (block 1114). Method 1100 includes associating the corresponding safety rating with the VOD safety record (block 1116). Method 1100 includes updating a stored copy of the VOD safety record with the VOD data and the corresponding safety rating, the VOD safety record being accessible via a network portal to at least one insurance company computer for use during evaluation of insurability and premium cost for insuring one or more of the vehicle, the operator, or the driver (block 1118).

Referring now to FIG. 12, method 1200 begins at start block and proceeds to block 1202 which includes the RMOSR DPS 110 receiving and evaluating event data. At decision block 1204, method 1200 includes determining whether or not a corrective action is required based on the event data received and preset criteria for triggering specific ones of the corrective actions available within the database associated with the specific category and type of event. In response to determining that a corrective action is required, method 1200 includes determining and assigning a specific set of corrective actions, from among a plurality of corrective actions within the database, the specific set of corrective actions being predetermined to at least one of (i) mitigate the safety-related event and (ii) reduce a re-occurrence of the specific/associated type of safety-related event (block 1206). Method 1200 includes generating a notification with the corrective action(s) identified and a timeframe (or due date) for completion of the corrective action (block 1208). Method 1200 includes transmitting the corrective action notification with the assigned set of corrective actions and a recommended response time to a second device associated with at least one of the operator, the driver, and the vehicle, with instructions for the operator and/or driver to perform the corrective action within a prescribed timeframe (block 1210).

In one or more embodiments, transmitting the notification with the assigned set of corrective actions to a second device includes transmitting a driver notification via one or more of a text message, an email, a direct notification to an installed app on a driver's mobile communication device, a calendar item populating a driver's electronic calendar, and a pop-up action item within an interface of an electronic logging device of the driver's commercial vehicle.

Method 1200 includes initiating a timer concurrently with transmitting the notification with the assigned set of corrective actions and monitoring for receipt of confirmation of completion of the corrective action (block 1212). Method 1200 also includes tracking, using the timer and completion signal received from another device, a response time of the driver or operator to complete the assigned set of corrective actions. Method 1200 includes determining and applying a safety rating adjustment factor from among a graduated scale of safety rating adjustment factors, based on the response time of the driver or operator, the safety rating adjustment factor being one of a lower positive or a higher negative adjustment factor for faster response times and even more negative adjustment factor for longer response times and response times that are longer than the recommended response time.

Specifically, in the illustrative embodiment, method includes determining, at decision block 1214, if the corrective action has been completed within the provided timeframe. In response to the corrective action being completed within the provided timeframe, method 1200 includes updating a safety rating of the corresponding entity (i.e., the driver/operator/vehicle) with a positive adjustment factor (block 1216). In response to the corrective action not being completed within the provided timeframe, method 1200 includes updating a safety rating of the corresponding entity with a negative adjustment factor (block 1218). Method 1200 then includes providing the current adjusted safety rating to any requesting or subscribed entity, including the shipper, insurance company computer, operator device, etc. (block 1220). According to one embodiment, a shipper or operator can be subscribed to RMOSR DPS to receive an automatic notification whenever an operator, driver, or vehicle safety rating falls by a certain value or falls below a pre-established threshold value. Method 1200 then ends.

In one or more embodiments, a more granular process for safety rating adjustment is implemented, where a starting adjustment factor (e.g., a first value) is assigned based on the type and severity of the event. Accordingly, method 1200 would include determining a negative adjustment factor to assign to an operator/driver safety rating in response to receipt of the VOD data identifying occurrence of the safety-related event. Method 1200 also includes: assigning and transmitting, within the corrective action notification, a specific time frame for the driver/operator to complete the corrective action; and monitoring for receipt of confirmation, within the assigned timeframe, that the driver/operator has completed the recommended corrective action. Then, in response to confirmation that the driver/operator completed the corrective action within the assigned time frame, method 1200 includes reducing the negative adjustment factor from a first value to a second value that is less negative than the first value. Method 1200 includes adjusting an overall operator/driver safety rating to a first updated operator/driver safety rating by applying the second value to a current operator/driver safety rating, and updating the driver/operator safety record to reflect the first updated operator/driver safety rating.

Method 1200 also includes, in response to not receiving confirmation of completion by the operator/driver of the corrective action within the established time frame: incrementing the negative adjustment factor to a third value that is more negative than the first value. Method 1200 then include: adjusting the overall operator/driver safety rating to a second updated operator/driver safety rating by applying the third value to the current operator/driver safety rating; and updating the driver/operator safety record to reflect the second updated operator/driver safety rating.

In one or more embodiments, method 1200 also includes transmitting a notification of the adjustment to the operator/driver safety rating to at least the mobile communication device of the driver/operator. Method 1200 also includes, in response to a request for current operator/driver/vehicle safety ratings by an insurance company, providing the updated, current operator/driver safety rating to a device of the requesting insurance company. Accordingly, the insurance company device can autonomously and objectively compute an insurance premium for the operator, driver and/or the vehicle, in part based on the current, updated operator/driver safety rating.

According to one or more embodiments, the method 1200 also includes maintaining an electronic library of different course materials, links to specific secondary resources, and information about in-person courses that each correspond to specific ones of the different types of events that require corrective actions. Method 1200 includes identifying one or more mitigating learning materials/resource associated with the assigned set of corrective actions for the safety-related event and incorporating the one or more mitigating learning materials/resource within the corrective action notification transmitted to the driver. Method 1200 then includes incorporating driver completion of one or more of the mitigating learning materials/resource within an evaluation of adjustments made to the driver safety rating. Each different mitigating learning materials/resource may have a different adjustment value applied to the driver's safety rating adjustment, and the driver can complete multiple different mitigating learning materials/resource to receive a combined larger positive rating adjustment.

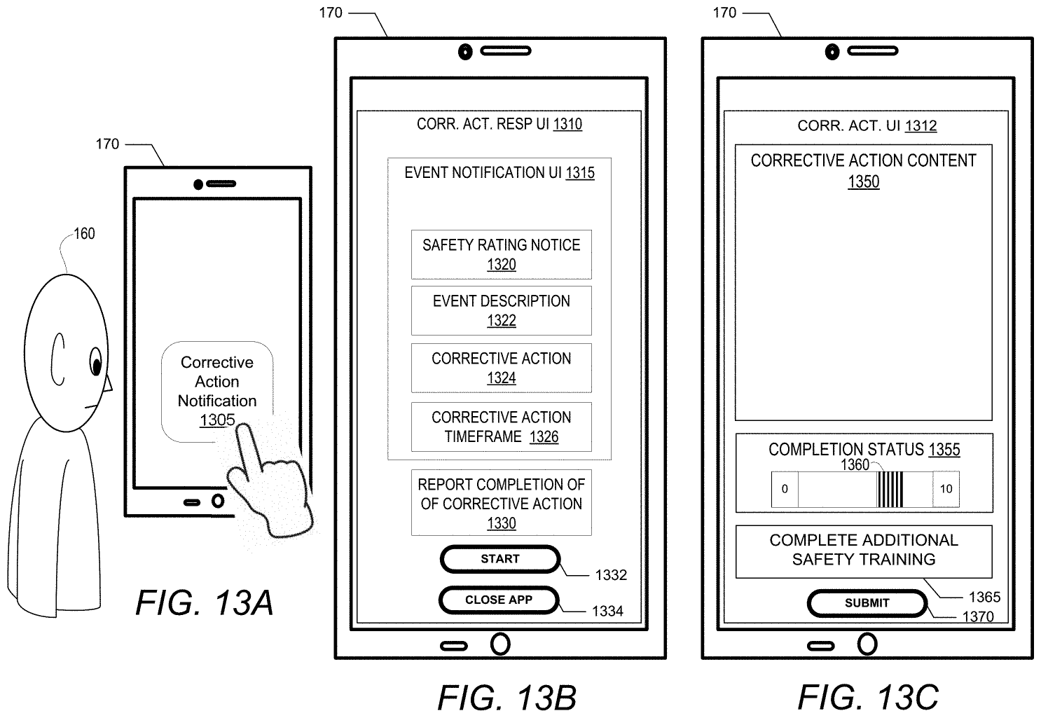

FIGS. 13A-13C illustrate three example graphical user interfaces (GUIs) of driver/operator mobile communication device (MCD) generated by an app following receipt of a corrective action notification and driver interfacing within the corrective action application, in accordance with various embodiments. According to one aspect, the driver/operator's MCD 170 is configured with one or more applications, including the corrective action response app 172, which enables the presentation to the driver/operator of one or more corrective actions user interfaces (UIs), as presented and described herein.

At FIG. 13A, driver 160 receives a corrective action notification/message 1305 on driver/operator MCD 170. When notification 1305 is selected, corrective action response user interface (UI) 1310 opens on driver/operator MCD 170 (FIG. 13B). In the illustrative embodiment, corrective action response UI 1310 presents event notification UI 1315, which includes safety rating notice 1320, event description 1322, corrective action (name and/or description) 1324, and corrective action timeframe (due date) 1326. Corrective action response user interface (UI) 1310 also presents a start button 1332 to begin or initiate the corrective action, close app button 1334, and completion of corrective action reporting option/selection 1330.

Selection of the start button 1332 opens corrective action user interface (UI) 1312 (FIG. 13B), which presents corrective action content window 1350, a completion status tracking bar 1355, with an indicator 1360 showing the amount of the corrective action that has been completed. Corrective action user interface (UI) 1312 also provides complete additional safety training option 1365, which provides additional corrective actions that the driver can complete to improve his/her safety rating and/or reduce the negative effects of the particular event that trigger the corrective action. Submit button 1370 allows the driver/operator to indicate when the corrective action has been completed from within the UI 312.

As will be appreciated, implementation of the functional features of the disclosure described herein can involve use of a combination of hardware, firmware, as well as several software-level constructs (e.g., program code and/or program instructions and/or pseudo-code) that execute to provide a series of methods that present the different features and functions of the disclosure.

It is understood that the use of specific component, device and/or parameter nomenclature is for example only and not meant to imply any limitations on the described embodiments. The embodiments may thus be described with different nomenclature and/or terminology utilized to describe the components, devices, parameters, methods and/or functions herein, without limitation. References to any specific proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that terms is utilized.

The above description is an extended summary and therefore, should not to be taken in a limiting sense, and the scope of the present disclosure will be defined by appended claims and equivalents thereof. Other aspects of the disclosure that stem from and/or are extensions of the above-described processes are presented generally within the aforementioned descriptions and/or the figures accompanying this submission. Nothing within the present descriptions are to be taken as limiting on the scope of the greater application of the disclosure within the shipping and transportation industry/space or more general perishable product space.

Implementation of the functional features of the disclosure described herein is provided within processing devices and/or structures and can involve use of a combination of hardware, firmware, as well as several software-level constructs (e.g., program code and/or program instructions and/or pseudo-code) that execute to provide a specific utility for the device or a specific functional logic. The presented figures illustrate both hardware components and software and/or logic components.

Those of ordinary skill in the art will appreciate that the hardware components and basic configurations depicted in the figures may vary. The illustrative components are not intended to be exhaustive, but rather are representative to highlight essential components that are utilized to implement aspects of the described embodiments. For example, other devices/components may be used in addition to or in place of the hardware and/or firmware depicted. The depicted example is not meant to imply architectural or other limitations with respect to the presently described embodiments and/or the general invention.

The description of the present innovation has been presented for purposes of illustration and description but is not intended to be exhaustive or limited to the innovation in the form disclosed. Many modifications and variations will be apparent to those of ordinary skill in the art without departing from the scope and spirit of the innovation. The embodiments were chosen and described in order to best explain the principles of the innovation and the practical application, and to enable others of ordinary skill in the art to understand the innovation for various embodiments with various modifications as are suited to the particular use contemplated.

What is claimed is:

1. A data processing system (DPS) comprising:
a communication subsystem that enables the DPS to communicatively connect to a plurality of second electronic devices via at least one network to receive and transmit shipment, carrier, and driver related data;
a memory having stored thereon a risk management and operator safety rating (RMOSR) module with program code for determining and assigning a safety and insurability rating to one or more of a driver, an operator, and a commercial vehicle, based on collected real-time data and historical data; and
at least one processor communicatively coupled to the communication subsystem and to the memory, the at least one processor processing the program code for the RMOSR module, which configures the DPS to:
receive, from at least one network-connected, second electronic device via the communication subsystem, a plurality of vehicle, operator, and/or driver (VOD) data associated with events involving and a respective safety rating of the vehicle, operator and/or driver;
aggregate the received VOD data into a VOD safety record associated with at least one of the driver and the operator;
determine, by evaluating the VOD data along with any previously-received, historical VOD data, a corresponding safety rating associated with one or more of the driver and the operator;
associate the corresponding safety rating with the VOD safety record; and
update a stored copy of the VOD safety record with the VOD data and the corresponding safety rating, the VOD safety record being accessible via a network portal to at least one insurance company computer for use during evaluation of insurability and premium cost for insuring one or more of the vehicle, the operator, or the driver.

2. The DPS of claim 1, wherein the processor:
parses the received VOD data for information corresponding to a safety-related event involving the driver or vehicle:
accesses available contextual data related to the vehicle, driver, operator, geographic location, road and traffic conditions, weather, or environment provided by at least one secondary device or sensor that provides a corresponding sensor data and is communicatively linked to the DPS;
categorizes a type and severity of the safety-related event, in part based on any received contextual data; and
updates the VOD safety record based on the type and severity of the safety-related event.

3. The DPS of claim 2, wherein the processor further:
determines and assigns a specific set of corrective actions, from among a plurality of corrective actions within a database, the specific set of corrective actions being predetermined to at least one of (i) mitigate the safety-related event and (ii) reduce a re-occurrence of an associated type of safety-related event; and
transmits a corrective action notification with the assigned set of corrective actions and a recommended response time to a second device associated with at least one of the operator, the driver, and the vehicle, with instructions for the operator and/or driver to perform the corrective action within a prescribed timeframe.

4. The DPS of claim 3, wherein in transmitting the notification with the assigned set of corrective actions to a second device, the processor transmits a driver notification via one or more of a text message, an email, a direct notification to an installed app on a driver's mobile communication device, a calendar item populating a driver's electronic calendar, and a pop-up action item within an interface of an electronic logging device of the driver's commercial vehicle.

5. The DPS of claim 3, wherein the processor:
initiates a timer concurrently with transmitting the notification with the assigned set of corrective actions;
tracks, using the timer and completion signal received from another device, a response time of the driver or operator to complete the assigned set of corrective actions; and
determines and applies a safety rating adjustment factor from among a graduated scale of safety rating adjustment factors, based on the response time of the driver or operator, the safety rating adjustment factor being one of a lower positive or a higher negative adjustment factor for faster response times and even more negative adjustment factor for longer response times and response times that are longer than the recommended response time.

6. The DPS of claim 3, wherein the processor:
determines a negative adjustment factor to assign to an operator/driver safety rating in response to receipt of the VOD data identifying occurrence of the safety-related event;
assigns and transmits, within the corrective action notification, a specific time frame for the driver/operator to complete the corrective action;
monitors for receipt of confirmation, within the assigned timeframe, that the driver/operator has completed the recommended corrective action; and
in response to confirmation that the driver/operator completed the corrective action within the assigned time frame:
reduces the negative adjustment factor from a first value to a second value that is less negative than the first value;
adjusts an overall operator/driver safety rating to a first updated operator/driver safety rating by applying the second value to a current operator/driver safety rating; and
updates a driver/operator safety record to reflect the first updated operator/driver safety rating.

7. The DPS of claim 6, wherein the processor:
in response to not receiving confirmation of completion by the operator/driver of the corrective action within the assigned time frame:
increments the negative adjustment factor to a third value that is more negative than the first value;
adjusts the overall operator/driver safety rating to a second updated operator/driver safety rating by applying the third value to the current operator/driver safety rating; and
updates the driver/operator safety record to reflect the second updated operator/driver safety rating.

8. The DPS of claim 7, wherein the processor:
transmits a notification of an adjustment to the operator/driver safety rating to at least the mobile communication device of the driver/operator; and
in response to a request for current operator/driver/vehicle safety ratings by an insurance company, provides an updated, current operator/driver safety rating to a device of the requesting insurance company, wherein the insurance company device autonomously and objectively computes an insurance premium for the operator, driver and/or the vehicle, in part based on the current, updated operator/driver safety rating.

9. The DPS of claim 1, wherein the processor:
maintains an electronic library of different course materials, links to specific secondary resources, and information about in-person courses that each correspond to specific ones of different types of events that require corrective actions;
identifies one or more mitigating learning materials/resource associated with an assigned set of corrective actions for the safety-related event;
incorporates the one or more mitigating learning materials/resource within a corrective action notification transmitted to the driver; and
incorporates driver completion of one or more of the mitigating learning materials/resource within an evaluation of adjustments made to the driver safety rating, wherein each different mitigating learning materials/resource may have a different adjustment value applied to the driver's safety rating adjustment and the driver can complete multiple different mitigating learning materials/resource to receive a combined larger positive rating adjustment.

10. The DPS of claim 1, wherein the processor:
matches the VOD data with pre-identified types of event data that are each correlated to specific safety metrics having associated thresholds utilized for evaluating driver and operator safety ratings;
correlates the driver and operator safety rating to an insurability rating that is assigned to the corresponding driver and/or operator, the insurability rating being utilized as an objective measure to determine a cost of insurance provided to the driver and/or operator by an insurance provider; and
provides the insurability rating as accessible data within an insurance company portal accessible via the network by computer devices of insurance companies.

11. A method comprising:
receiving, from at least one network-connected, second electronic device via a communication subsystem of a risk management and operator safety rating (RMOSR) data processing system (DPS), a plurality of vehicle, operator, and/or driver (VOD) data associated with events involving and a respective safety rating of the vehicle, operator and/or driver;
aggregating the received VOD data into a VOD safety record associated with at least one of the driver and the operator;
determining, by evaluating the VOD data along with any previously-received, historical VOD data, a corresponding safety rating associated with one or more of the driver and the operator;
associating the corresponding safety rating with the VOD safety record; and
updating a stored copy of the VOD safety record with the VOD data and the corresponding safety rating, the VOD safety record being accessible via a network portal to at least one insurance company computer for use during evaluation of insurability and premium cost for insuring one or more of the vehicle, the operator, or the driver.

12. The method of claim 11, further comprising:
parsing the received VOD data for information corresponding to a safety-related event involving the driver or vehicle:
accessing available contextual data related to the vehicle, driver, operator, geographic location, road and traffic conditions, weather, or environment provided by at least one secondary device or sensor that provides a corresponding sensor data and is communicatively linked to the DPS;
categorizing a type and severity of the safety-related event, in part based on any received contextual data; and
updating the VOD safety record based on the type and severity of the safety-related event.

13. The method of claim 12, further comprising:
determining and assigning a specific set of corrective actions, from among a plurality of corrective actions within a database, the specific set of corrective actions being predetermined to at least one of (i) mitigate the safety-related event and (ii) reduce a re-occurrence of an associated type of safety-related event; and
transmitting a corrective action notification with the assigned set of corrective actions and a recommended response time to a second device associated with at least one of the operator, the driver, and the vehicle, with instructions for the operator and/or driver to perform the corrective action within a prescribed timeframe.

14. The method of claim 13, wherein transmitting the notification with the assigned set of corrective actions to a second device comprises transmitting a driver notification via one or more of a text message, an email, a direct notification to an installed app on a driver's mobile communication device, a calendar item populating a driver's electronic calendar, and a pop-up action item within an interface of an electronic logging device of a driver's commercial vehicle.

15. The method of claim 13, further comprising:
initiating a timer concurrently with transmitting the notification with the assigned set of corrective actions;
tracking, using the timer and completion signal received from another device, a response time of the driver or operator to complete the assigned set of corrective actions; and
determining and applying a safety rating adjustment factor from among a graduated scale of safety rating adjustment factors, based on the response time of the driver or operator, the safety rating adjustment factor being one of a lower positive or a higher negative adjustment factor for faster response times and even more negative adjustment factor for longer response times and response times that are longer than the recommended response time.

16. The method of claim 13, further comprising:
determining a negative adjustment factor to assign to an operator/driver safety rating in response to receipt of the VOD data identifying occurrence of the safety-related event;
assigning and transmitting, within the corrective action notification, a specific time frame for the driver/operator to complete the corrective action;
monitoring for receipt of confirmation, within the assigned timeframe, that the driver/operator has completed the recommended corrective action; and
in response to confirmation that the driver/operator completed the corrective action within the assigned time frame:
reducing the negative adjustment factor from a first value to a second value that is less negative than the first value;
adjusting an overall operator/driver safety rating to a first updated operator/driver safety rating by applying the second value to a current operator/driver safety rating; and
updating a driver/operator safety record to reflect the first updated operator/driver safety rating.

17. The method of claim 16, further comprising:
in response to not receiving confirmation of completion by the operator/driver of the corrective action within the assigned time frame:
incrementing the negative adjustment factor to a third value that is more negative than the first value;
adjusting the overall operator/driver safety rating to a second updated operator/driver safety rating by applying the third value to the current operator/driver safety rating; and
updating the driver/operator safety record to reflect the second updated operator/driver safety rating.

18. The method of claim 17, further comprising:
transmitting a notification of the adjustment to the operator/driver safety rating to at least a mobile communication device of the driver/operator; and
in response to a request for current operator/driver/vehicle safety ratings by an insurance company, providing an updated, current operator/driver safety rating to a device of the requesting insurance company, wherein the insurance company device autonomously and objectively computes an insurance premium for the operator, driver and/or the vehicle, in part based on the current, updated operator/driver safety rating.

19. The method of claim 11, further comprising:
maintaining an electronic library of different course materials, links to specific secondary resources, and information about in-person courses that each correspond to specific ones of different types of events that require corrective actions;
identifying one or more mitigating learning materials/resource associated with the assigned set of corrective actions for the safety-related event;
incorporating the one or more mitigating learning materials/resource within a corrective action notification transmitted to the driver; and
incorporating driver completion of one or more of the mitigating learning materials/resource within an evaluation of adjustments made to the driver safety rating, wherein each different mitigating learning materials/resource may have a different adjustment value applied to the driver's safety rating adjustment and the driver can complete multiple different mitigating learning materials/resource to receive a combined larger positive rating adjustment.

20. The method of claim 11, further comprising:
matching the VOD data with pre-identified types of event data that are each correlated to specific safety metrics having associated thresholds utilized for evaluating vehicle, driver and operator safety ratings;
correlating the driver and operator safety rating to an insurability rating that is assigned to the corresponding driver and/or operator, the insurability rating being utilized as an objective measure to determine a cost of insurance provided to the driver and/or operator by an insurance provider; and
providing the insurability rating as accessible data within an insurance company portal accessible via the network by computer devices of insurance companies.

21. The method of claim 20, further comprising:
detecting a login by an insurance device to the RMOSR DPS via the insurance company portal;
receiving an entry of an operator identifier associated with an operator being tracked by within a VOD safety rating DB;
accessing the VOD safety records of the operator within the VOD safety rating DB; and
generating and displaying a graphical user interface (GUI) presenting a set of formatted information comprising a VOD safety rating of the operator and a plurality of additional events and data utilized within a determination of the VOD safety rating that collectively provides a snapshot of the insurability of the operator.

22. The method of claim 11, further comprising:
detecting a login by an operator device to the RMOSR DPS via an operator accessible portal;
identifying an operator ID associated with the login;
retrieving, from the VOD safety rating DB, a plurality of operator related VOD event data and VOD safety ratings corresponding to one or more drivers and one or more vehicles managed by an operator associated with the operator ID;
presenting, within a series of graphical user interfaces, formatted data representing a historical view of events associated with at least one of the one or more drivers and the one or more vehicles; and
presenting, within at least one graphical user interface (GUI), an overview of an insurability rating of at least one of the operator, the one or more drivers, and the one or more vehicles.

23. The method of claim 22, further comprising:
generating and presenting a set of corrective action GUIs comprising a corrective action assigning GUI and a corrective action tracking GUI; and
in response to a selection of the corrective action assigning GUI:
presenting a list of drivers and associated events that can require a corrective action;
enabling operator selection of a specific corrective action from a plurality of pre-established corrective actions to assign to a selected driver;
enabling operator selection of a due date for completing the corrective action; and
automatically forwarding the corrective action with the due date to a device of the driver to whom the corrective action is assigned.

24. The method of claim 23, further comprising:
in response to selection of the corrective action tracking GUI:
generating and presenting a GUI with a select list of drivers to whom a corrective action has been previously assigned for completion;
populating within the GUI a completion status of each corrective action assigned, including an indication of which corrective actions have not been completed by the assigned due date; and
activating a driver notification and correction protocol, which informs each driver who has not completed an assigned corrective action by the assigned due date of a penalty other recourse action to be imposed on that driver.

25. A data processing system (DPS) comprising:
a communication subsystem that enables the DPS to communicatively connect, via at least one network, to a device providing risk management and operator safety rating (RMOSR) functionality;
a memory having stored thereon a communication module; and
at least one processor communicatively coupled to the communication subsystem and to the memory, the at least one processor configuring the communication subsystem to connect with the RMOSR device to:
login to the RMOSR device, via an operator portal at the RMOSR device using an operator ID;
access via the operator portal from a VOD safety DB, a plurality of operator-related VOD event data and VOD safety ratings corresponding to one or more drivers and one or more vehicles managed by an operator associated with the operator ID;
display, within a series of graphical user interfaces, formatted data representing a historical view of events associated with at least one of the one or more drivers and the one or more vehicles;
present, within at least one graphical user interface (GUI), an overview of an insurability rating of at least one of the operator, the one or more drivers, and the one or more vehicles;
present a set of corrective action GUIs comprising a corrective action assigning GUI and a corrective action tracking GUI;
receive and transmit an input selecting the corrective action assigning GUI:
present a list of drivers and associated events that can require a corrective action;
receive and transmit a selection of a specific corrective action from a plurality of pre-established corrective actions to assign to a selected driver;
receive and transmit a next selection of a due date for completing the corrective action; and
trigger an automatic forwarding of the corrective action with the due date to a device of the driver to whom the corrective action is assigned.

26. The data processing system (DPS) of claim 25, wherein the processor further configures the DPS to:
receive a selection of the corrective action tracking GUI:
present a GUI with a select list of drivers to whom a corrective action has been previously assigned for completion;
populate within the GUI a completion status of each corrective action assigned, including an indication of which corrective actions have not been completed by the assigned due date; and
activate a driver notification and correction protocol at the RMOSR device, which informs each driver who has not completed an assigned corrective action by the assigned due date of a penalty other recourse action to be imposed on that driver.
